(19) United States
(12) Patent Application Publication
(10) Pub. No.: US 2025/0233512 A1
(43) Pub. Date: Jul. 17, 2025

(54) DC-DC CONVERTER

(71) Applicants: Fraunhofer-Gesellschaft zur Förderung der angewandten Forschung e.V., München (DE); Friedrich-Alexander-Universität Erlangen-Nürnberg, in Vertretung des Freistaates Bayern, Erlangen (DE)

(72) Inventors: Yan ZHOU, Erlangen (DE); Kilian DREXLER, Erlangen (DE)

(73) Assignees: Fraunhofer-Gesellschaft zur Förderung der angewandten Forschung e.V., München (DE); Friedrich-Alexander-Universität Erlangen-Nürnberg, in Vertretung des Freistaates Bayern, Erlangen (DE)

(21) Appl. No.: 19/017,816

(22) Filed: Jan. 13, 2025

(30) Foreign Application Priority Data
Jan. 11, 2024 (EP) 24151415.7

(51) Int. Cl. H02M 1/32; H02J 1/10; H02M 3/158

(52) U.S. Cl. CPC H02M 1/325; H02J 1/102; H02M 3/158

(57) ABSTRACT

A DC-DC converter includes a converter circuit including a switchable first circuit path that is in a conductive state in a first time interval and that has at least a first and a second switchable element interconnected in series, and including a second circuit path that is coupled to the first circuit path by way of an inductive element and that is in a conductive state in second time interval disjunct from the first time interval, wherein there is a time lag between the first time interval and the second time interval. A control device is configured to switch the first circuit path. A switchable freewheeling path is coupled in parallel with the inductive element, wherein the control device is configured to switch the switchable freewheeling path temporarily to a conductive state in a freewheeling interval during the time lag.

### CROSS-REFERENCE TO RELATED APPLICATION

This application claims priority from European Application No. 24151415.7, which was filed on Jan. 11, 2024, and is incorporated herein by reference in its entirety.

### TECHNICAL FIELD

The present invention relates to a DC-DC converter. The present invention relates in particular to semiconductor isolation for DC-DC converters and, in some embodiments, to a fault protection measure for an isolating DC-DC converter based on semiconductor isolation.

### BACKGROUND OF THE INVENTION

One aim of current developments is to implement DC-DC converters using transistors. The known technology presents possibilities involving semiconductor isolation, for instance in the publication “New Cascaded Converter Topologies for Transformerless Galvanic Active Isolation”, wherein such topologies are limited to the use of low voltages and low powers.

Known topologies are insufficient for increasing operating voltages and higher power ranges. On the one hand, it is difficult to ensure simultaneous switch-off of transistors in a real technical implementation, as is required in the known technology. Moreover, the coil current has already built up prior to switching. This coil current may adversely affect or even damage the circuit during switching. By way of example, a potential applied diagonally in two DC networks may thus be connected erroneously by a diode and the transistor with delayed switch-off, which may cause an abrupt potential shift in both DC systems of the DC-DC converter and may generate a high clocked interfering current. On the other hand, it may be the case that two DC systems are diagonally connected directly to the respective other clocked transistor and the isolation and the potential separation are destroyed if a transistor is no longer able to be switched off during operation due to a defect. This defect is particularly critical when a coil current has built up.

DC-DC converter topologies that are able to work with high voltages and powers and at the same time still allow a low noise level during operation would therefore be desirable.

One object of the present invention is therefore to provide a DC-DC converter that makes it possible to work with high voltages and powers and at the same time still ensure a low noise level during operation, that is to say a low degree of electromagnetic interference.

### SUMMARY

According to an embodiment, a DC-DC converter may have: a converter circuit including a switchable first circuit path that is in a conductive state in a first time interval and that has at least a first and a second switchable element interconnected in series, and including a second circuit path that is coupled to the first circuit path by way of an inductive element and that is in a conductive state in second time interval disjunct from the first time interval, wherein there is a time lag between the first time interval and the second time interval; a control device configured to switch the first circuit path; and a switchable freewheeling path coupled in parallel with the inductive element, wherein the control device is configured to switch the switchable freewheeling path temporarily to a conductive state in a freewheeling interval during the time lag.

One core concept of the present invention is that of having recognized that a defined and in particular switchable freewheeling path in parallel with the inductive element, the coil, of the DC-DC converter makes it possible to absorb and/or dissipate the coil current, during the switching operation in a defined freewheeling interval, into the freewheeling path, and thus into a circuit independent of two DC links. While this enables problem-free switching of the switching elements of the DC links, it also provides a possibility of dissipating the coil current in the event of a fault, namely via the ohmic resistance of the freewheeling path, which, in addition to high powers and voltages, at the same time enables low noise levels.

According to an embodiment, a DC-DC converter includes a converter circuit having a switchable first circuit path having at least a first and a second switchable element interconnected in series and having a second circuit path coupled to the first circuit path by way of an inductive element. The first circuit path is in a conductive state during a first time interval and the second circuit path is in a conductive state during a disjunct second time interval, wherein there is a time lag between the end of the first time interval and the beginning of the second time interval and/or, in particular taking into account the possibly periodic driving of the elements, between the end of the second time interval and the beginning of the first time interval. The DC-DC converter includes a control device that is configured to switch the first and, in some dependent embodiments, also the second circuit path. Provision is furthermore made for a switchable freewheeling path that is coupled in parallel with the inductive element, wherein the control device is configured to switch the switchable freewheeling path to a conductive state temporarily during a freewheeling interval during the duration of the time lag between the first time interval and the second time interval. This allows local freewheeling and/or makes it possible to dissipate the coil current in the freewheeling interval.

According to an embodiment, the second circuit path includes at least a third and possibly also a fourth switchable element interconnected in series therewith, for instance in a manner similar or symmetrical to the first circuit path. The control device may be configured to switch the third and/or fourth switchable element. Alternative embodiments make provision, instead of the third or fourth switchable element, to use a diode that switches passively by way of the current that is flowing or the potential that is present.

According to an embodiment, the freewheeling path, in a conductive state, is in a bidirectionally conductive state and/or, in a non-conductive state, is in a bidirectionally blocking state. This is particularly advantageous when using semiconductor switches in the freewheeling path, these possibly behaving differently along different current flow directions.

According to an embodiment, the freewheeling path has at least one switching element that, in the conductive state, is in a bidirectionally conductive state and, in the non-conductive state, is in a bidirectionally non-conductive state, as may be achieved for example with mechanical switches. As an alternative or in addition, the freewheeling path may have a first switching element that, in the non-conductive state, is in a unidirectionally blocking state along a first direction of the freewheeling path. The freewheeling path includes a second switching element that, in the non-conductive state, is in a unidirectionally blocking state along an opposite second direction of the freewheeling path. The first switching element and the second switching element are interconnected such that, in the non-conductive state, the freewheeling path is in a blocking state in the first direction and/or the second direction. This allows the two switching elements, for instance semiconductor switches, to complement one another.

In accordance with an embodiment that focuses on this, the freewheeling path includes a first semiconductor switch and a second semiconductor switch that are coupled in antiseries with one another, for instance mutually adjacent drain terminals or collector terminals. This makes it possible to overcome the different behaviours of the semiconductor switches along different current flow directions while at the same time utilizing the advantages of semiconductor elements, such as fast switching frequencies, small size and good controllability. In such a configuration, it is likewise possible to configure the freewheeling path by driving the semiconductor switches between the bidirectionally non-conductive state, the bidirectionally conductive state and a state that is unidirectionally conductive for a specific first or second current direction in a manner equivalent to a diode having a settable blocking direction. The unidirectional states may for example be used to prepare for current commutation from the first and second circuit path to the freewheeling path. With reference to FIG. 3a, FIG. 4a, FIG. 5a and FIG. 6b, a transistor of the freewheeling path may possibly be configured or controlled into a unidirectional state before the start of a freewheeling interval as time interval 54, as described in detail in connection with FIG. 3a.

According to an embodiment, the control device is configured to switch the freewheeling interval at times at which the switchable elements of the first circuit path switch to a blocking state and the second circuit path is in a blocking state. The freewheeling path allows the coil current to flow away, avoiding interfering currents at least as far as possible.

According to an embodiment, the control device is configured to extend a duration of the freewheeling interval compared to a preceding freewheeling interval in order to reduce a switching frequency of the first and second circuit paths over several switching cycles and/or in order to shorten the duration of the freewheeling interval compared to the preceding freewheeling interval, in order to increase the switching frequency of the first and second circuit paths. This makes it possible to set a switching frequency independent of the operating point and thus to enable different operating states.

According to an embodiment, the DC-DC converter includes a detection device that is coupled to the first circuit path and the second circuit path and is configured to detect a potential change between the first circuit path and the second circuit path. The control device is configured, based on the potential change, to at least partially terminate the switching of the first circuit path and possibly the switching of switchable elements in the second circuit path. This makes it possible to prevent damage due to continued operation with defective elements.

According to an embodiment, the second circuit path includes at least a third and optionally also a fourth switchable element. The control device is configured, based on the potential change, to likewise at least partially terminate the switching of the second circuit path.

According to an embodiment, the detection device includes an RC member having a resistive element and a capacitive element and is configured to detect a voltage drop across the resistive element and/or the capacitive element in order to detect the potential change. This enables particularly simple and error-proof detection of the potential difference, which may indicate a loss of isolation capability of at least one of the circuit paths.

According to an embodiment, the control device is configured to switch the switchable freewheeling path to a conductive state in the event of a detected potential change. This makes it possible to avoid further potentially harmful interfering currents.

According to an embodiment, the control device is configured to switch the first circuit path and/or the second circuit path to a blocking state in the event of a detected potential change. In other words, in the event of a detected erroneous potential change, the switching elements are switched off or switched to a blocking state. This also makes it possible to avoid or at least reduce currents that could cause damage.

According to an embodiment, the control device is configured to control the DC-DC converter in at least one of a continuous mode, a discontinuous mode, a trapezoidal mode with a coil current having an alternating mathematical sign, and a limit mode. This allows the DC-DC converter to be used in a wide variety of applications.

According to an embodiment, the DC-DC converter includes a plurality of converter circuits and a corresponding plurality of detection devices that are each coupled to one of the plurality of converter circuits in order to monitor same. This enables converter circuit-specific monitoring, while coupling to a plurality of the converter circuits enables a small number of detection devices. Both designs may easily be combined with one another by virtue of some of the plurality of converter circuits installed in the DC-DC converter being monitored in combination by a detection device and other converter circuits being monitored individually or in a second group.

According to an embodiment, provision is made for a DC-DC converter in which the occurrence of the potential change in response to driving of a driven switchable element in the first circuit path, of a switchable element of a second circuit path in the second circuit path or of a switchable element in the freewheeling path unambiguously indicates another element of the converter circuit as a defective element.

According to an embodiment, the DC-DC converter includes a plurality of converter circuits connected in parallel. The control device is configured to control the plurality of converter circuits with a time offset in relation to one another such that, at any time, a path of at most one converter circuit is switched. The detection device is coupled to the plurality of converter circuits in order to unambiguously identify a potential change of each of the converter circuits.

### BRIEF DESCRIPTION OF THE DRAWINGS

Embodiments of the present invention will be explained below with reference to the accompanying drawings, in which:

FIG. 1 shows a schematic block diagram of a DC-DC converter according to an embodiment;

FIG. 2a shows a schematic block diagram of a DC-DC converter according to an embodiment in which switching elements of a freewheeling path are interconnected in antiseries;

FIG. 2b shows a schematic block diagram of a monitoring circuit according to an embodiment;

FIG. 3a shows an exemplary timing diagram on a matching time axis for driving of the switching elements of the DC-DC converter from FIG. 2a in a TraCM operating mode according to an embodiment;

FIG. 3b shows a schematic depiction of a table containing fault states, as may be detected within the scope of embodiments, of a DC-DC converter in a trapezoidal mode;

FIGS. 3c-d show schematic curves of voltages and currents of a DC-DC converter in a fault state according to an embodiment;

FIG. 4a shows an exemplary timing diagram of drive signals for the switches and the switches of the freewheeling path from FIG. 2a in a continuous current mode, CCM, and a discontinuous current mode, DCM, according to an embodiment;

FIG. 4b shows a schematic depiction of a table containing fault states, as may be detected within the scope of embodiments, of a DC-DC converter in a continuous current mode;

FIG. 5a shows a schematic exemplary illustration of the drive signals for the switching elements and the switching elements of the freewheeling path together with an exemplary schematic curve of the coil current it for a negative coil current according to an embodiment;

FIG. 5b shows a schematic depiction of a table containing fault states, as may be detected within the scope of embodiments, of a DC-DC converter in a discontinuous current mode;

FIG. 6a shows a schematic block diagram of a DC-DC converter according to an embodiment, in which switching elements from FIG. 2a are replaced by diodes;

FIG. 6b shows curves of the coil current and the gate signals for the unidirectional variant of FIG. 6a, building on the illustrations of FIG. 3a and FIG. 4a, according to an embodiment;

FIG. 6c is a schematic illustration of the coil current from FIG. 3a in the case of a varied freewheeling interval driven according to the invention;

FIG. 6d shows a schematic depiction of a table containing fault states, as may be detected within the scope of embodiments, of a DC-DC converter in a unidirectional mode;

FIGS. 7a-b show schematic diagrams for explaining a fault detection possibility when a switching element of the freewheeling path of a DC-DC converter is switched off, according to an embodiment;

FIGS. 8a-b show schematic diagrams for explaining a fault detection possibility when another switching element of the freewheeling path of a DC-DC converter is switched off, according to an embodiment;

FIGS. 9a-b show schematic diagrams for describing a fault detection possibility when a second circuit path is switched on, according to an embodiment;

FIGS. 10a-b show schematic diagrams for describing a fault detection possibility when a first circuit path is switched on, according to an embodiment; and

FIG. 11 shows an exemplary table for the breakdown of decision conditions for fault detection or fault localization based on the voltage drop in a DC-DC converter according to the invention.

### DETAILED DESCRIPTION OF THE INVENTION

Before embodiments of the present invention are explained in more detail below with reference to the drawings, it is pointed out that identical or functionally identical elements, objects and/or structures or those having the same effect in the different figures are provided with the same reference signs, and so the description of these elements as set forth in different embodiments may be interchanged with one another or may be applied to one another.

Embodiments described below are described in connection with a large number of details. However, embodiments may also be implemented without these detailed features. Furthermore, for reasons of intelligibility, embodiments are described using block diagrams as a substitute for a detailed illustration. Moreover, details and/or features of individual embodiments may by all means be combined with one another, provided that no explicit description is given to the contrary.

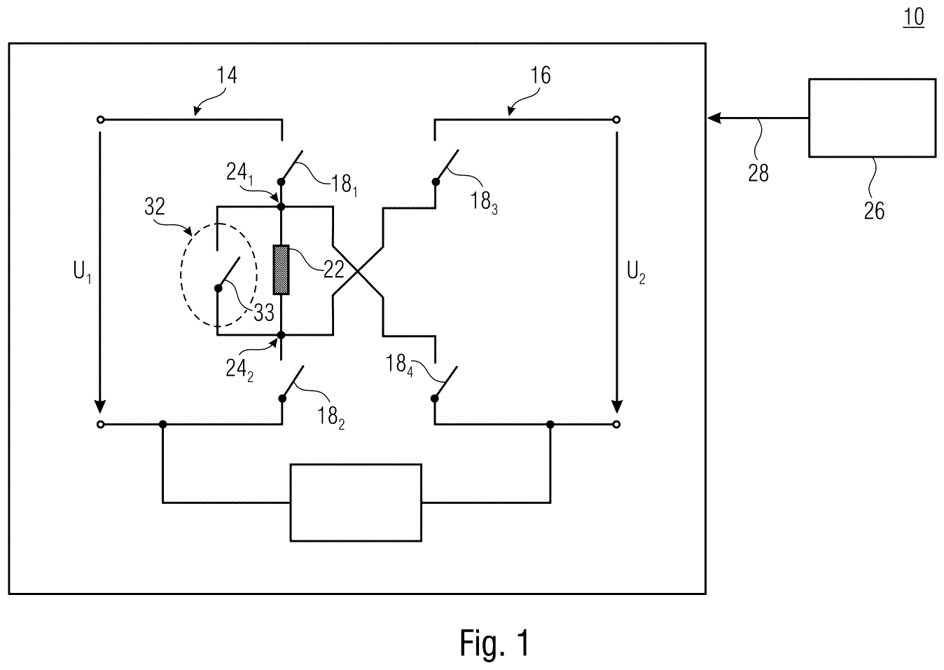

FIG. 1 shows a schematic block diagram of a DC-DC converter 10 according to an embodiment. The DC-DC converter 10 includes a converter circuit 12 having a first circuit path 14 and a second circuit path 16. The circuit path 14 includes a circuit path having switchable elements 18₁ and 18₂ that are connected in series with one another, these including for example mechanical switches, but advantageously semiconductor switches such as transistors, such as bipolar transistors, IGBTS or MOSFETS. IGBTS and bipolar transistors are not normally conductive along a second direction, for which reason they may be combined with a diode connected in antiparallel, which diode, in the case of a MOSFET, may be implemented in whole or in part by a monolithic body diode. The circuit paths 14 and 16 are coupled to one another by an inductive element, for instance by virtue of coupling points 241 and 242 of the first circuit path 14 between the switchable element 18₁ and the inductive element 22, on the one hand, and between the switchable element 18₂ and the inductive element 22, each being cross-coupled to the switchable element 18₄ and 18₃, respectively. The second circuit path 16 is, for example but not necessarily, formed by two switchable elements 18₄ and 18₃, which are interconnected in series with one another. It is pointed out at this juncture that the switchable elements 18₃ and 18₄ are not necessarily switchable, but that other elements that change their conductive property in the circuit may also be used, for example diodes that change their conductivity depending on the respective current flow direction.

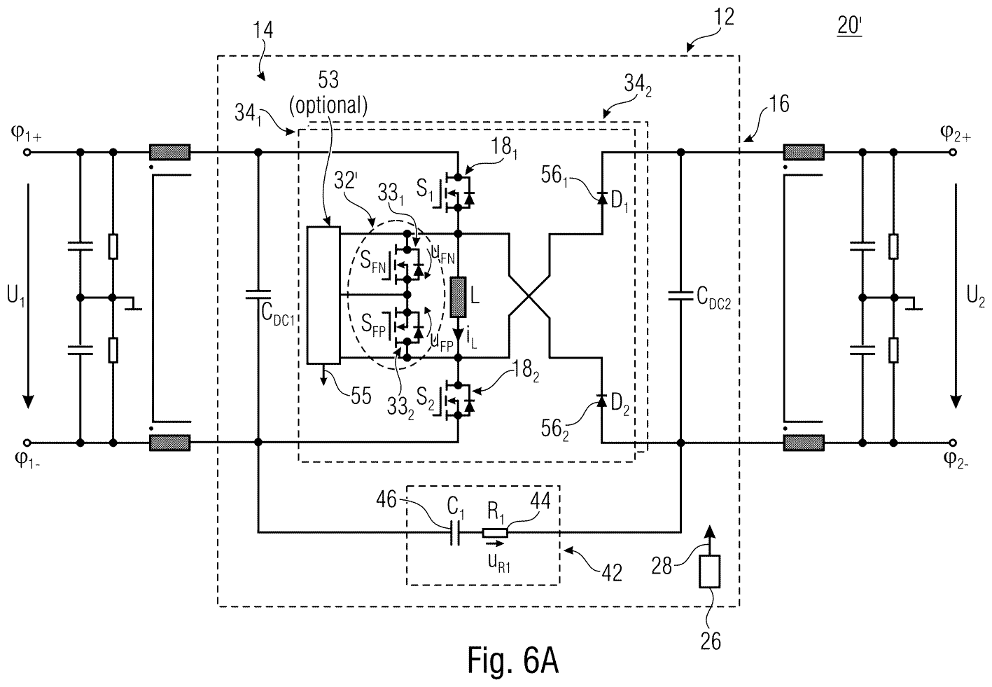

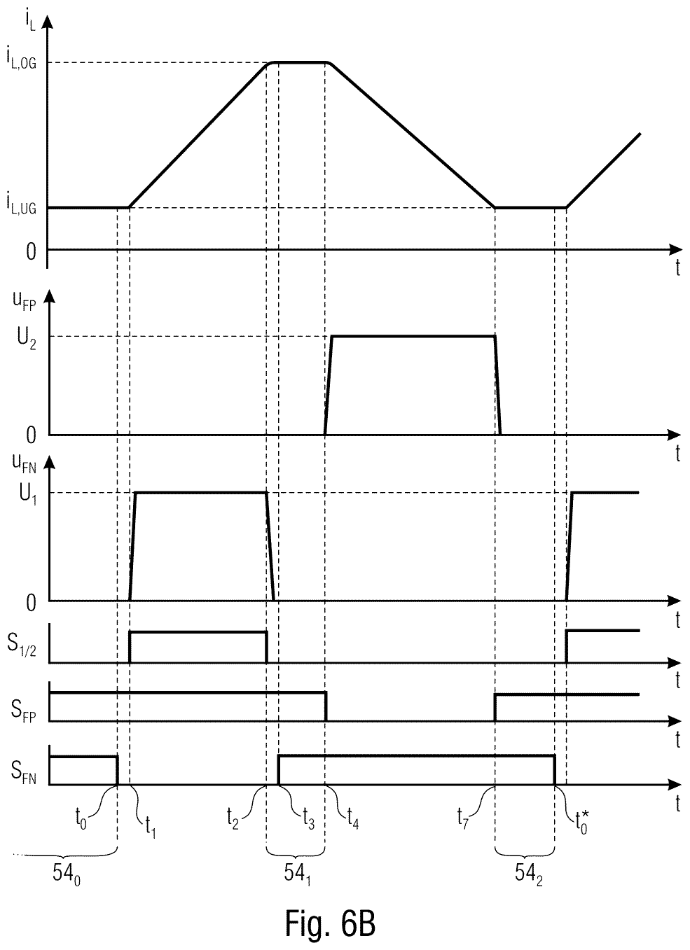

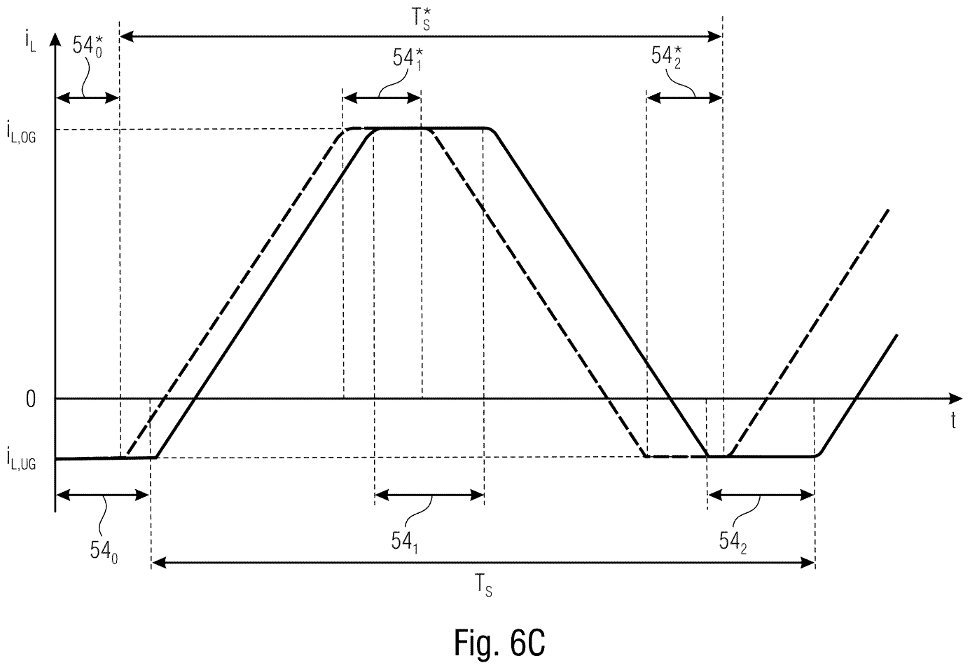

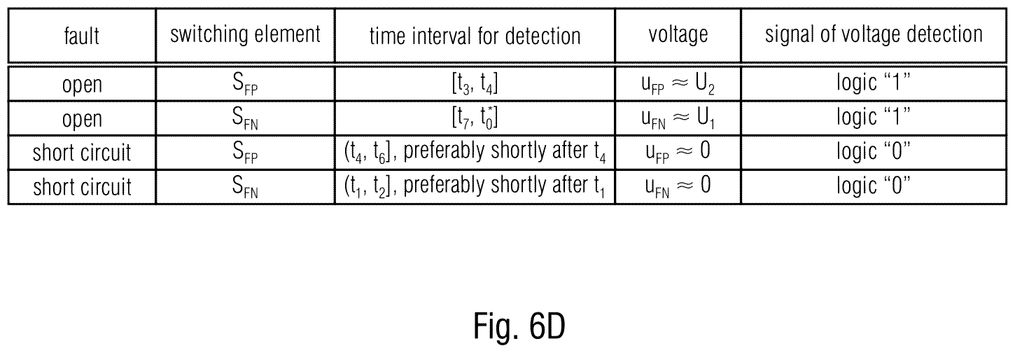

The DC-DC converter includes a control device 26 configured to switch at least the circuit path 14, for example by virtue of a state of the switching elements 18₁ and 18₂ being adjusted based on a control signal 28 from the control device 26. In the case of an implementation or arrangement of the switchable elements 18₃ and 18₄ in the circuit path 16, the control device 26 may be configured to control these elements as well. However, it is likewise within the scope of embodiments for the second circuit path 16 to change between a conductive and a blocking property due to a changing direction of applied voltages and/or currents, for instance by virtue of diodes being used in accordance with the explanations regarding FIG. 6a.

The DC-DC converter includes a switchable freewheeling path 32, which is coupled in parallel with the inductive element 22. The control device 26 is configured to switch the switchable freewheeling path 32 temporarily to a conductive state in a freewheeling interval for the freewheeling of the coil current, which may for example lead to the centre taps 241 and 242 being short-circuited or at least connected to their own ohmic resistance. Electric current present in the inductive element 22 may thereby be dissipated.

The switchable freewheeling path 32 includes a switchable element 33, which may be driven for example by the control device 26 and may be controlled with regard to at least unidirectional but advantageously bidirectional conductivity. It is likewise possible to use a higher number than one switchable element, for instance in order to interconnect a plurality of unidirectionally controllable elements in antiseries.

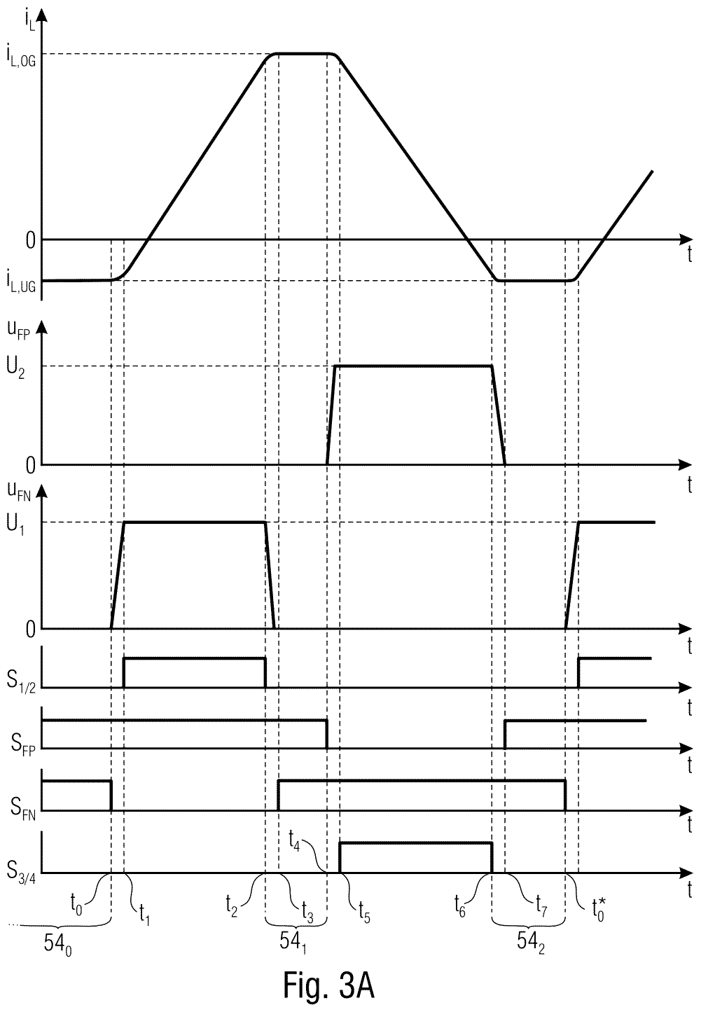

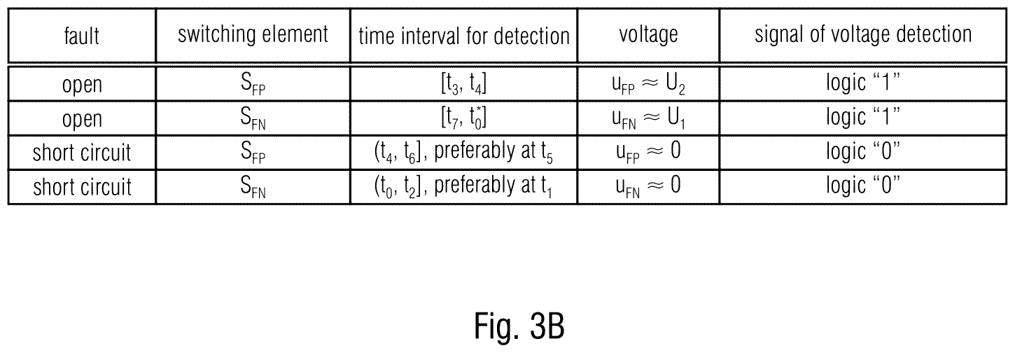

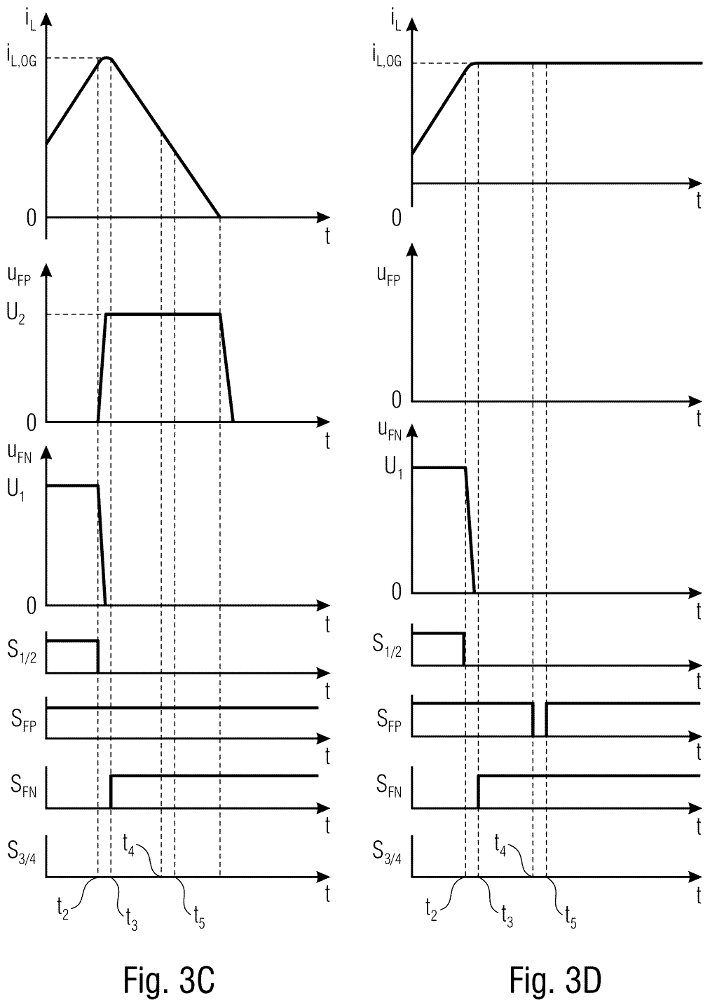

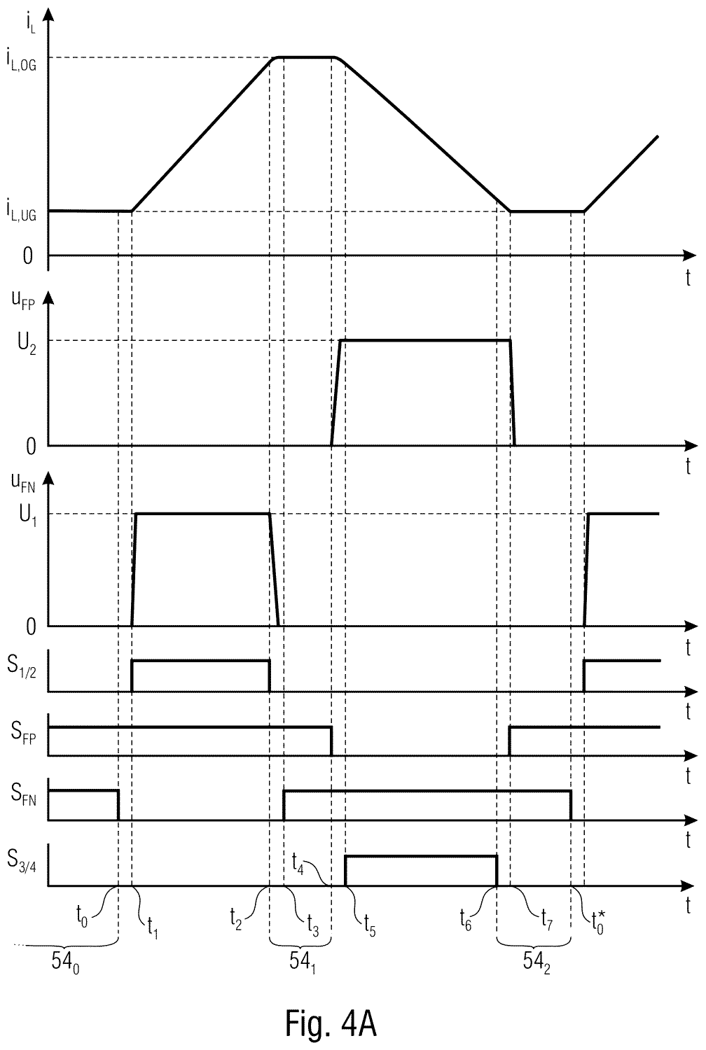

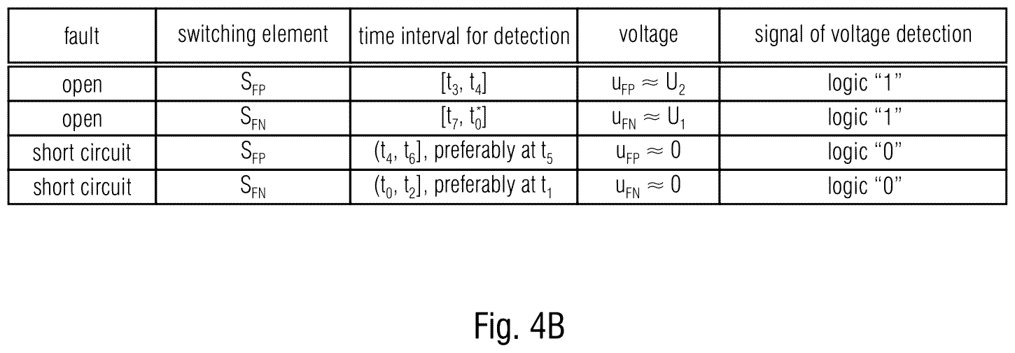

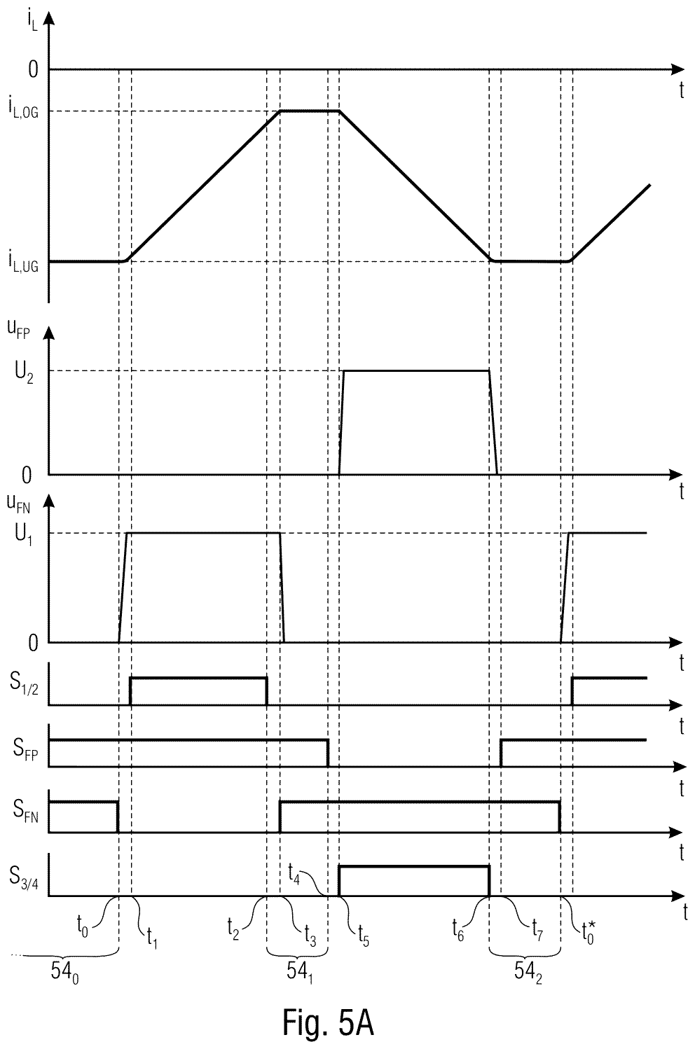

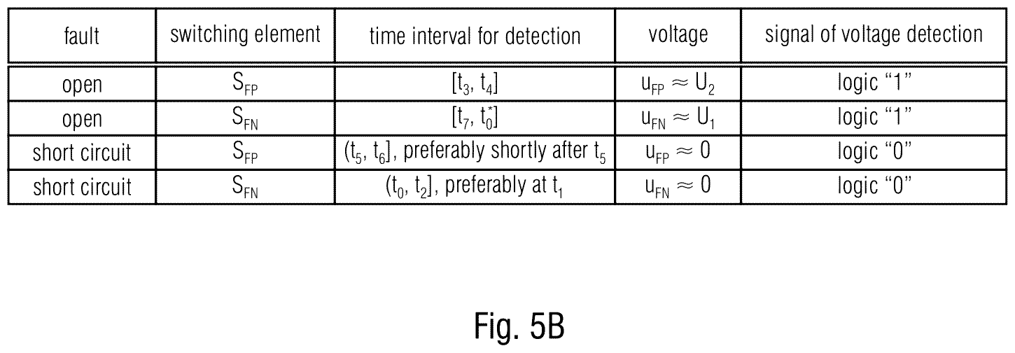

The DC-DC converter is configured such that the first circuit path is in a conductive state during a first time interval and the second circuit path is in a conductive state during a disjunct second time interval, wherein there is a time lag between the first time interval and the second time interval. Accordingly, as an alternative or in addition, a time lag may also be arranged between the second time interval and the first time interval or, equivalently, a further third time interval in which control is carried out in a manner corresponding to the first time interval, since the elements, where possible, are driven periodically or in periodic alternation. This means that a fourth time interval, following the third time interval, is able to be controlled in the same way as the second time interval. Exemplary timing diagrams are illustrated in FIG. 3a, FIG. 4a, FIG. 5a and FIG. 6b. It may be seen therein that the first time interval ends for example at a time t₂ and the second time interval begins at a time t₅, wherein, after the time t₂, it is possible to wait for a commutation period of around 100 ns up to around 1,000 ns until, in a freewheeling interval 54 that ends promptly prior to a duration possibly required by a commutation, the freewheeling path 32 is in a conductive state.

This means that, after a time interval in which the circuit path 14 is in a conductive state and is therefore in a blocking state along at least one, advantageously both directions, but before the second circuit path 16 is in a conductive state, that is to say as long as it is (still) in a blocking state, due to active driving and/or due to diode properties, the control device 26 is able to switch the freewheeling path to a conductive state and, in particular before the second circuit path 16 is in a conductive state, to switch the freewheeling path back to a blocking state, at least in the relevant current flow direction. This achieves a situation whereby, during the time lag, based on the freewheeling path, a current of the inductive element 22 is able to flow away, which may reduce loading on the elements of the circuit paths 14 and/or 16. Embodiments make provision, at any time, for at most one of the two circuit paths 14 or 16 to be in a conductive state.

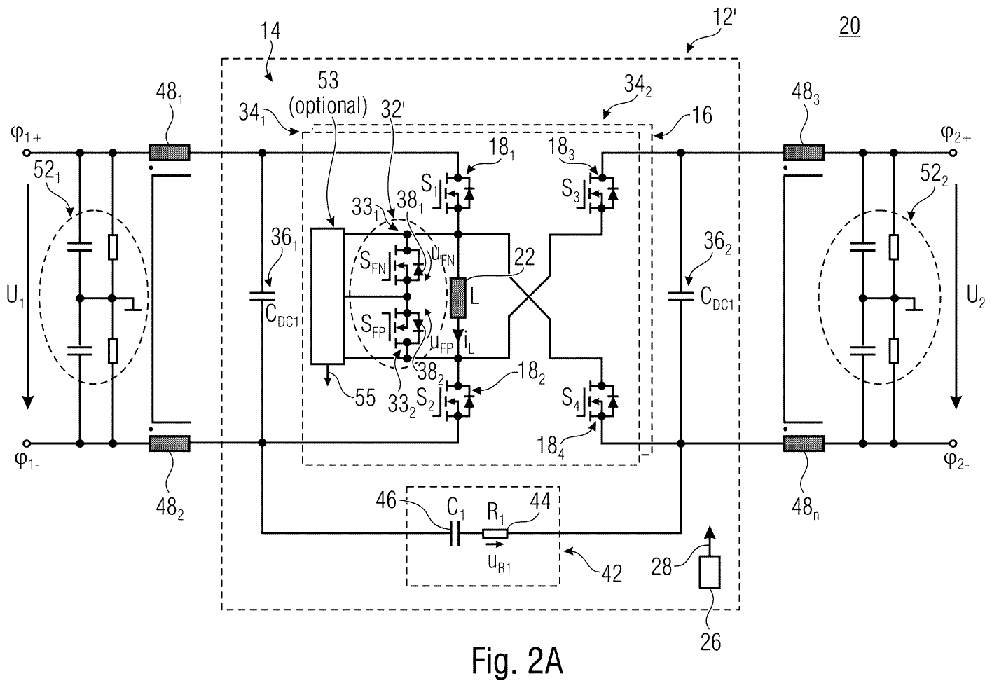

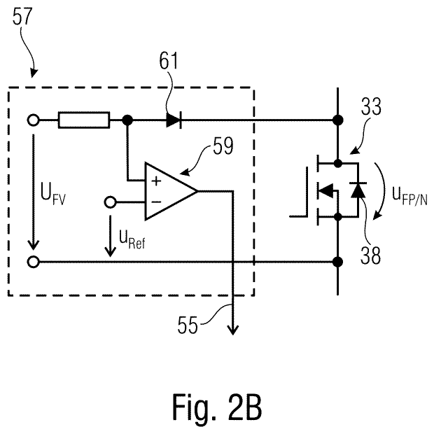

FIG. 2a shows a schematic block diagram of a DC-DC converter 20 according to an embodiment.

A converter circuit 12′, illustrated with additional details compared to the DC-DC converter 10, of the DC-DC converter 20 includes one or more phase circuits 34₁, 34₂, . . . , wherein the number of phase circuits may, as desired, be at least 1, at least 2, at least 3 or more. The phase circuits 34 may be connected in parallel with one another at input and at output in order to divide the total current flowing through the DC-DC converter and thus to keep the current loading in the respective elements low. As an alternative or in addition, provision may be made to keep the output current continuous and/or to reduce the loading on the capacitors of the DC-DC converter.

The switching elements 18₁ to 18₄ are for example MOSFET transistors or GaN FETS and are denoted S₁, S₂, S₃ and S₄ A coil current in may flow through the inductive element 22, identified by the symbol L.

Also illustrated are DC link capacitances 36₁ of a first DC-DC converter side and 36₂ of a second DC-DC converter side, these being identified by C_{DC1} and C_{DC1}, respectively. For the DC link or the circuit path 14, potentials φ₁₊ and φ₁₋ are illustrated by way of example, between which the DC link capacitance 36₁ is arranged. In a comparable manner, potentials φ₂₊ and φ₂₋ are illustrated, between which the DC link capacitance 36₂ is arranged.

A voltage U₁ may be present on a first side and a voltage U₂ may be present on a second side of the DC-DC converter 20. One of the two voltages U₁ and U₂ may be referred to as the input voltage and the other may be referred to as the output voltage between which the DC-DC converter 20 converts the voltage.

A freewheeling path 32′, which is coupled in parallel with the inductive element 22, includes for example two semiconductor switches 33₁ and 33₂ interconnected in antiseries with one another, these being implemented for example in MOSFET configurations and being identified by S_{FN} and S_{FP}.

This configuration makes it possible, in the event of both switchable elements 33₁ und 33₂ being switched to a blocking state, to obtain a bidirectionally blocking property based on the body diodes 381 and 382 and the open states of the conductive paths. In the driven state, it is possible to obtain a bidirectionally conductive path by bypassing the body diodes 381 and 38₂.

It is possible to achieve a situation whereby, both in the DC-DC converter 10 and in the DC-DC converter 20, the freewheeling path 32 or 32′, in a conductive state, is in a bidirectionally conductive state and, in a non-conductive state, is in a bidirectionally blocking state. When using only one semiconductor switch 33₁ or 33₂, on the other hand, a unidirectionally blocking state is achieved in combination with a bidirectionally conductive state.

While the DC-DC converter 10 is able to be switched to a bidirectionally conductive state and a bidirectionally non-conductive state with possibly a single switching element 33, in the DC-DC converter 20, provision is made to use a first switching element 33₁ and a second switching element 33₂, which, in the non-conductive state, are each in a unidirectionally blocking state along different directions. The switching elements 33₁ and 33₂ are interconnected such that, in the non-conductive state, the freewheeling path is in a blocking state along both directions, that is to say bidirectionally, for which purpose the switching elements 33₁ and 33₂ are interconnected in antiseries with one another.

Provision is advantageously made in this regard for the semiconductor switches to have adjacent drain terminals or adjacent collector terminals, depending on the type of implementation of the semiconductor transistors.

Regardless of the implementation of the freewheeling path 32′ and the implementation of the circuit path 16 and other developments according to the invention, the DC-DC converter may include a detection device 42 that is coupled to the circuit paths 14 and 16 and is configured to detect a potential change between the circuit path 14 and the second circuit path 16. Such a potential change between the circuit paths 14 and 16 may be taken into account by the control device 26 in order, based thereon, to terminate the switching of at least the first circuit path, that is to say of the switch 18₁ and/or 18₂. In one configuration of the circuit path 16 or of the circuit path whereby it has switchable elements, such as the switchable elements 18₃ and 18₄, the control device 26 may likewise be configured to terminate the switching of these elements based on the detected potential change, wherein it is perfectly possible to drive a safe state of the respective element, for instance a blocking state, which is then retained, and then to terminate the further driving.

Such an embodiment solves another problem in relation to the known technology. On the one hand, the combinatorial operation of the switchable freewheeling path and the potential change detection solves the problem that, during normal operation, the freewheeling path offers a possibility of ensuring a certain transition time for the current commutation between the active state of the switches S_{1/2} and S_{3/4}. The switching elements S₁ to S₄ are switched off here and ensure isolation. Another problem that is solved is that the freewheeling path offers an energy release point, decoupled from both sides, for the energy stored in the coil, which is operational even after fault detection of the switching elements. This means that isolation continues to be ensured in the event of a simple fault.

In the illustration of FIG. 2a, the detection device 42 is coupled between the potentials φ₁₋ and φ₂₋. As an alternative, it is also possible to select any other constellations, for instance between the potentials φ₁₊ and φ₂₊ and corresponding diagonal connections of the potentials φ₁₊ and φ₂₋ or φ₁₋ and φ₂₊.

Based on the potential change, the control device 26 may be configured to switch the switchable freewheeling path 32′ to a conductive state. The detection device 42 may also by all means be used in the DC-DC converter 10, wherein the switchable element 32 is able to be switched to a conductive state by the control device 26 in the event of a detected potential change.

According to an embodiment of the detection device 42, it includes an RC member having a resistive element 44, identified by R₁, and a capacitive element 46, identified by C₁. The detection device 46 is configured to detect a voltage drop URI across the resistive element 44 and/or a voltage drop across the capacitive element 46 in order to detect the potential change. By way of example, a measuring device of the detection device or a corresponding measuring device of the control device 26 may be coupled to the detection device 42 or the elements 44 and/or 46 in order to detect the potential change.

Furthermore, in FIG. 2a, for the DC-DC converter 20, an optional, albeit advantageous enhancement is described with reference to a monitoring device 53. The monitoring device 53 may be configured to monitor a voltage drop across at least part of the freewheeling path 32′. The control device 26 may be configured, by way of example, to detect a fault state of the freewheeling path 32′ based on the voltage drop or information or a signal 55 provided by the monitoring device 53. Based on the fault state, the control device 26 may at least partially terminate or prevent the switching of the first circuit path 14, as described for example in connection with the detection device 42. The monitoring device 53 may also be used in the DC-DC converter 10, for instance in conjunction with the switchable element 33.

For this advantageous embodiment of the monitoring device 53, it has been recognized that monitoring the freewheeling path and in particular the switchable element or at least one of the switchable elements may provide an indicator as to whether the operation of the freewheeling path is provided reliably or a fault is present here. It has thus been recognized that, depending on whether the switchable element 33, 33₁ or 33₂ is switched to a conductive or non-conductive state, a voltage drop significantly different from 0 (non-conductive state) is expected, or a substantially short-circuited state with a low voltage drop (conductive state) is expected. The monitoring device 53 may be configured to monitor this behaviour depending on the switching state of the freewheeling path and to output a corresponding signal 55, which may be provided to the control device 26 so that, based on the voltage drop, it is able to detect a fault state of the freewheeling path 32′, which makes it possible, based on the fault state, to at least partially terminate or adjust the switching of the circuit path 14.

In other words, the implementation of the monitoring device 53 enables a voltage monitoring circuit or monitoring device 53, connected in parallel to the switching elements of the freewheeling circuit S_{FP} and S_{FN}, which is able to detect the voltages across the switches during operation. Using the voltage monitoring circuit, the control device 26 is able to diagnose the fault in the freewheeling circuit, for example based on the control signals and the detected voltage states.

FIG. 2b shows a schematic block diagram of a voltage monitoring circuit 57 according to an embodiment, which voltage monitoring circuit may be part of the monitoring device 53 and for example implemented or arranged twice in the DC-DC converter 20, for instance individually for each of the switchable elements 33₁ and 33₂ if both are to be monitored, wherein monitoring of just one of the elements is also possible.

The monitoring device 53 may be configured, according to an embodiment, to compare a voltage drop u_{FP} and/or u_{FN} of the freewheeling path 32/32′ with a constant or configurable reference value u_{Ref}, to provide a comparison result and to provide same to the control device in order to detect the fault state. The reference value may for example be set by the control device 26 to be changeable over time or may be configurable, for example depending on the switching state of the DC-DC converter or at least one switching element thereof.

According to an embodiment, the voltage monitoring circuit 57 may be configured to compare an actual voltage drop across the switching element 33, for instance the voltage u_{FP} across the switching element 33₂ or the voltage u_{FN} across the switching element 33₁, with a reference voltage u_{Ref}. Said reference voltage may change over time depending on the driven state of the switching element 33, wherein, based on this comparison and with knowledge of the driven state, the control device 26 is able to detect whether or not the voltage drop corresponds to the target state or whether or not the detected conductive state or short circuit corresponds to the target state. A deviation from the target state may be interpreted as a fault state.

In other words, in order to avoid the two main hazards during operation of a DC-DC converter and to reduce the subsequent influence, embodiments make provision to combine a suitable protective measure with the corresponding detection method and to use it in a topology for detecting the isolation fault. The protective measure is able to detect the isolation fault that happens to be present during operation and to limit the influence to a small local circuit in the circuit by reducing or restricting the further operation of the DC-DC converter.

If applying the possibility of using several of the phase circuits 34 in the DC-DC converter 20, then embodiments make provision for these to be driven with a time offset in relation to one another, such that, at any time, a path of at most one converter circuit is switched. Since the switching of the path may lead to the onset of or detectability of the potential difference at the detection device 42, it is also possible, based on the temporal distinguishability, to detect which of the phase circuits 34 is defective. The detection device may be coupled to the plurality of converter circuits in order to unambiguously identify a potential change in each of the converter circuits. Thus, for example, the detection device 42 may be contact-connected to a respectively coupled potential point φ₁₊ or φ₁₋ and φ₂₊ or φ₂₋ and in accordance with the selected parallel interconnection. This makes it possible to monitor several phase circuits 34 using one detection device.

As an alternative or in addition, for a plurality of converter circuits as phase circuits 34, it is possible to use a corresponding plurality of detection devices 42 that are each coupled to one of the plurality of converter circuits in order to monitor same. These may also be combined with one another such that different converter circuits or phase circuits are coupled to an individual detection device and other converter circuits or phase circuits are monitored in groups.

In the event that a potential change is detected by way of the detection device 42, the control device 26 may be configured, as an alternative or in addition to setting the switching of one or more of the switchable elements in the circuit paths 14 and 16, to switch the freewheeling path 32 to a conductive state.

In addition, the control device may be configured to open the operational remaining switching elements of the switches S₁ to S₄, that is to say to switch them to a blocking state. If one of these switching elements is not able to be switched off due to a defect, then the three remaining switches remain in the blocking state and thus ensure isolation between the DC networks.

According to an embodiment, the control device 26, however, in the event of a detected potential change, attempts to switch the circuit path 14 and/or the circuit path 16 to a blocking state, that is to say to control elements 18₁, 18₂, 18₃ and/or 18₄, provided they are controllable and provided they are not defective, into an open state.

In other words, embodiments make it possible to introduce, into a DC-DC converter topology, a bidirectional switch as a predefined local freewheeling circuit or freewheeling path and potential shift detection as the fault detection means. This is illustrated in FIG. 2a. There are two DC networks 14 and 16 on the left-hand and right-hand side, respectively, whose voltages correspond to U₁ and U₂. The two DC link capacitors C_{DC1} and C_{DC1} connected to the DC networks are able to create two corresponding DC links for the circuit of the DC-DC converter. The current-compensated coils 481 to 484 and grounding devices 521 and 522, for example in the form of a high-ohm resistance and grounding capacitance, may be considered standard design for a DC-DC converter and the DC network.

With regard to the design of the topology, it is of advantage for the operating conditions φ₁₊ >φ₂₋ and φ₂₊>φ₁₋ to be met, since otherwise the illustrated DC-DC converter loses its isolation capability between the two DC networks. The body diodes or freewheeling diodes of the switching elements are the reason for this.

The converter circuit 12′ in this case includes main aspects of the present embodiments. It contains one or more phase circuits 34, the detection device 42 and the control unit or the control device 26. If a plurality of phase circuits are used in a multi-phase application, the number of phase circuits 34 may be clocked in interleaved fashion.

In the illustrated but non-limiting embodiment, each phase circuit 34 includes four switching elements S₁, S₂, S₃, S₄, a coil L and the bidirectional switch connected in parallel to the coil, the freewheeling path 32 or 32′. In one possible embodiment, the freewheeling path 32′ includes two switching elements S_{FP} and S_{FN} connected in antiseries. The bidirectional switch is able to block or conduct the voltage and current from a selected direction or both directions through the driving of the corresponding gate signals.

The freewheeling path 32 makes it possible to create a possibility in the circuit to allow the coil current it to flow freely in a local circuit separated from the two circuit paths 14 and 16 independent potential. All of the switching elements may be implemented independently of one another and are advantageously semiconductor switches, such as MOSFETS or GaN-FETS, these advantageous embodiments not being limiting.

The switching elements S₁, S₂, on the one hand, and S₃ and S₄, on the other hand, may be considered as belonging to two switching groups, wherein, in each group, the switching elements are able to be switched as synchronously or simultaneously as possible at the logic level, even though this may also involve time delays in the real circuit design, for instance due to component deviations or different cable lengths. For a simplified illustration, the switching elements S₁, S₂ are also referred to here as being grouped as _{1/2}, and the switching elements S₃, S₄ are also referred to here as being grouped as _{3/4}.

During normal operation, the bidirectional switch may be activated between each switching interval by the switching elements S_{1/2} and S_{3/4}. During an activated interval, the coil current i_{L} flows through the bidirectional switch into a freewheeling step or through the freewheeling path. This ensures a sufficient time interval, usually from a few 100 ns up to μs, for confirming the switch-off in the switching elements S₁, S₂, S₃ and S₄, and the diagonal connection caused by the unequal switch-off delay of the switching elements is eliminated or its effect is neutralized.

As one fault detection possibility, the potential shift detection means or detection device 42 monitors the potential shift between the two circuit paths 14 and 16. If an abrupt potential shift occurs during the corresponding activation of the gate signals of the switching element and persists or lasts for some time, for instance a few 100 ns, the control device 26 or an evaluation unit of the detection device 42 may detect a fault, such as a diagonal connection of the circuit paths. Based thereon, the protection method may be carried out as soon as possible, in particular advantageously immediately and quickly. This may include permanently switching on the bidirectional switch or the freewheeling path, that is to say putting same into a conductive state, and switching off the switching elements S₁, S₂, S₃ and S₄ or switching them to the open state, and keeping them permanently in the switched-off state.

Such a protective measure according to the invention makes it possible to restrict the influence of a faulty switching element to a locally restricted area. In the event of failure of one of the switching elements S₁-S₄, the three remaining or still operable switching elements may enable or maintain the isolation capability between the two DC systems. The current stored in the coil or the energy contained therein may be released slowly in the bidirectional switch by the freewheeling.

Embodiments make provision to diagnose the faulty switching element using the mathematical sign of the potential shift and the gate signals, that is to say the driving of the control device 26.

According to embodiments, a control device of a DC-DC converter described herein is configured to control the DC-DC converter in at least one of a continuous mode, CCM, a discontinuous mode, DCM, a trapezoidal mode with an alternating mathematical sign of the coil current, TraCM and a limit mode, BCM. The control device may be configured to run or to operate one of the types of operation without a change or to switch between one or more of the types of operation.

FIG. 3a shows an exemplary timing diagram on a matching time axis t for driving of the elements S_{1/2}, S_{3/4} and of the switching elements 33₁ and 33₂, identified respectively by S_{FP} and S_{FN}, of the freewheeling path 32′. Also shown is a curve of the coil current I_{L}, wherein an upper limit OG and a lower limit UG are also described.

In order to achieve low switching losses, the topology described herein may be operated in a trapezoidal current mode, TraCM. Here, some or even all of the switching elements may be operated in a soft switching mode or what is known as a zero voltage switching (ZVS) mode. In the example illustrated in FIG. 3a, a current curve and the gate signals of the switching elements for obtaining the TraCM are shown. It may be seen that the mathematical sign of the coil current it alternates in each switching period, which means that a current flow direction changes, for which reason a bidirectionally conductive and a bidirectionally blocking freewheeling path is advantageously applied.

One possible switching sequence is as follows:

An exemplary switching period begins at the time to. The switching element S_{FN} is switched off, and the freewheeling step or the freewheeling interval 54₀ defined by the switches S_{FP} and S_{FN} being switched to a conductive state is terminated or aborted. The coil current i now charges the junction capacitance of the switching element S_{FN} and flows further through the diodes of the switching elements S₁ and S₂ into the DC link or U₁ in FIG. 2a.

The time intervals [t₀, t₁], [t₂, t₃], [t₄, t₀] and [t₆, t₇] may be regarded as a technically set dead time that delays the switch-on of the switching elements for the next step and takes into account the fact that, in the meantime, the junction capacitance of the switching elements is recharged by the coil current i_{L} flowing in the appropriate direction for zero voltage switching.

In the time interval [t₁, t₂], the switching elements S_{1/2} are switched on; during the time interval, the coil current is built up using the DC link voltage U₁.

At the time t₂, the switching elements S_{1/2} may be switched off. The coil current it now flows through the switching elements S_{FP} and S_{FN} in a freewheeling step or a freewheeling interval 54₁. Although the switching elements S_{1/2} are switched off simultaneously or with a slight delay, that is t₀ say not simultaneously, the active connection between the two circuit paths 14 and 16 is interrupted.

The time interval [t₂, t₄] may correspond t₀ the freewheeling step or the freewheeling interval 54₁; in the meantime, the switching elements S₁, S₂, S₃ and S₄ remain in a switched-off or blocking state. During this time, the potential of the coil L or of the inductive element 22 is actively isolated from both circuit paths.

At the time t₄, the switching element S_{FP} may be switched off. The coil current it now charges the junction capacitance of the semiconductor switch 33₂, and the coil current in then flows through the diodes of the switching elements S_{3/4} into the DC link U₂ or the circuit path 16.

In the time interval [t₅, t₆], the switching elements S_{3/4} may be switched on; during the time interval, the coil current is dissipated using the DC link voltage U₂.

At the time t₀, the switching elements S_{3/4} are switched off. The coil current it now flows through the switching elements S_{FP} and S_{FN} in a freewheeling step since, at the time t₇, the element F_{FP} is switched back to a conductive state.

The time interval [t₆, t₀*] corresponds to a freewheeling step 54₂; in the meantime, the switching elements S₁, S₂, S₃ and S₄ remain in the off state. During this time, the potential of the coil L is actively isolated from both circuit paths. The freewheeling path may be configured, by driving the antiparallel switches, into the states 1) completely or bidirectionally conductive, 2) completely or bidirectionally blocking, 3) unidirectionally conductive along a first direction, and 4) unidirectionally conductive along an opposite second direction. The unidirectionally conductive states 3) and 4) may behave in relation t₀ one another as with regard t₀ their polarization or a diode with a settable blocking direction that is able t₀ conduct the current in a selected direction. This unidirectionally conductive state is advantageously used, in the case of the trapezoidal operation described in FIG. 3a, to switch the freewheeling path where possible not to a bidirectionally conductive state, but to switch the freewheeling path as a diode with a changing blocking direction. It is possible to switch the switching element S_{FN} to a conductive state in the case of a positive coil current and to switch the switching element S_{FP} to a blocking state in the case of a negative coil current. The freewheeling intervals 54 may be considered here to last from the switch-off of the previous first or second circuit path until the switch-off of one of the bidirectional switches, since the start of the zero voltage switching of both circuit paths is considered to belong to a freewheeling step.

At the time t₀*, a next or subsequent switching period may occur; the switching elements continue to be driven due to the switching sequences. This means that repeated and/or periodic driving may take place. The first circuit path is in a conductive state during a first time interval between t₁ and t₂ and the second circuit path is in a conductive state during a disjunct second time interval between t₅ and t₆. Between the end of the first time interval and the beginning of the second time interval and/or, in particular taking into account the possible periodic driving of the elements, between the end of the second time interval and the beginning of a further time interval during which the first circuit path is switched to a conductive state after the time t₀*, which may also be referred to as a renewed first time interval or as a third time interval, there may be a time lag (t₅−t₂ and/or t₀*−t₆), which may be used to switch the freewheeling path to a conductive state. The DC-DC converter may be driven periodically here, possibly with a varying period duration.

It is advantageous to switch on the switching element S_{FP} prior to switching off the switching elements S_{1/2} at the time t₂ and to switch it off at the time t₄ in order to abort a freewheeling step. In a real implementation, the switch-on of the switching element S_{FP} may be brought about between the time t₇ of the last switching period and the time t₂. In particular, in order to reduce conductive losses in the bidirectional switch during the freewheeling step and to simplify control logic, the switching element S_{FP} may remain in the switched-on state between the time t₇ of the preceding switching period and the time t₄ of the current switching period.

Due to the same principle, the switching element S_{FN} has to be switched on prior to switching off the switching elements S_{3/4} at the time to and switched off at the time t₀* of the next switching period in order to abort a freewheeling step. In a real implementation, the switch-on of the switching element S_{FN} may be brought about in the time interval [t₃, t₆]. In particular, in order to reduce conductive losses in the bidirectional switch, the freewheeling path, during the freewheeling step or keep them low and to simplify control logic, the switching element S_{FN} may remain in the switched-on state between the times t₃ of the current time period and the time t₀* of the subsequent switching period.

In the trapezoidal current mode, a mathematical sign of alternating coil current it is provided. The direction and power of an energy transmission may be defined by the values of the upper and lower current limits i_{LOG} and i_{LUG} with i_{LOG}>0, i_{LUG}<0.

Furthermore, FIG. 3a illustrates a curve of voltages U₁ and U₂ that are able to be provided to the voltage monitoring circuit 57 as a reference voltage u_{Ref} in order to monitor the operation of the freewheeling path. In FIG. 3a, the voltages U₁ and U₂ are illustrated for the voltages u_{FN} and u_{FP} monitored by the voltage monitoring circuit 57, wherein other reference voltages or threshold values may also be suitable for robust voltage drop/short circuit monitoring. The voltage monitoring circuit 57 may be configured to monitor one or both voltages across the switching elements S_{FP} and S_{FN}; this value depends on the switching state.

In one example of normal operation, the voltages u_{FP} and u_{FN} during the freewheeling steps of the time interval [t₃, t₄] and [t₇, t*₀] may be very low; this means that u_{FP}≈0 and u_{FN}≈0, with deviations within the scope of component-inherent resistances and voltage drops having to be taken into account. Since each switching element is able to meet the condition for zero voltage switching (ZVS) during trapezoidal current operation, the voltage is able to be built up across a switching element after it has been switched off by the coil current; see in this regard the times t₀ and/or t₄. Zero voltage switching is advantageously driven for example at times t₀, t₂, t₄ and t₆, where a respective switching element is switched off. The voltages of different switching elements in a circuit may in this case assume complementary values, that is to say if one increases, one of the others decreases.

Due to this property, the voltage across the switching element S_{FN} should be built up within the time interval [t₀, t₂]; in particular, the voltage u_{FN} reaches the voltage U₁ in the time interval [t₁, T₂]. At the switching element S_{FP}, the voltage u_{FP} should be high during the time interval [t₄, t₆] and, in the time interval [t₅, t₆], it may be provided, as an expected value, that the voltage u_{FP} should correspond approximately to the voltage U₂, wherein U₁ and U₂ are significantly different from 0 and are for example from a few hundred to thousand volts (for instance 400 V to 800 V or 1000 V). By way of example, these values may represent the operating voltage of the DC-DC converter. The diode 61, illustrated in FIG. 2b, in the detection device 57 precisely brings about voltage blocking; if the drain-source voltage, Uds, has substantially built up, the diode 61 isolates Uds from the voltage comparator. This enables a relatively small and precise measuring range of the voltage comparator.

With reference again to FIG. 2b, this illustrates one possible embodiment as an example for the monitoring device 53. In this embodiment, a comparator 59 compares the switch voltage u_{FP} Or u_{FN} through a diode 61 with the reference voltage u_{Ref}, which corresponds to the voltage state of the switch element. The reference voltage is advantageously slightly greater than the voltage drop caused at the switching element by the coil current occurring during normal operation, for instance taking into account an example of 5 V to 15 V.

The decision condition may be understood as an interference band and voltage in the event of a fault. These depend on the dimensioning of the switches.

Since the operating voltage is significantly greater than the voltage in the conductive state, in one advantageous design, the reference voltage may be configured to be approximately 2 times or 3 times the voltage drop across the switching element during normal operation.

This means that, during normal operation, for example, Uds of the switching element may be significantly lower than the reference voltage; in the event of a fault, the diode 61 blocks U1 or U2 and the comparator 59 is also able to detect the state unambiguously using U_{FV}.

An isolating voltage source may supply power to the components in the voltage monitoring circuit 57 and for this purpose provide a voltage U_{FV} that is greater than the reference voltage, that is to say u_{Ref}<U_{FV}.

If the switch voltage u_{FP} or u_{FN}, combined as u_{FP/N}<U_{FV}, the diode 61 becomes conductive. The switch voltage is thus compared with the reference voltage. As long as the switching element is switched on so as to be operational or the current is conducted through the body diode or freewheeling diode 38, the comparator 59 delivers a logic signal “0” or ZERO as an indication of a voltage state for a low voltage. The voltage monitoring signal 55 and the target voltage states, obtained by analysis, may be used to diagnose the short-circuit fault and the open fault in the freewheeling circuit.

If a switching element in the freewheeling circuit is not able to conduct a current, this corresponds to an open fault. The coil current now commutates directly to the other side and the switch voltage u_{FP} or u_{FN}, in the freewheeling steps and the time intervals [t₃, t₄] or [t₇, t*₀], have a high voltage state. This fault is then detected by the voltage monitoring circuit and delivered to the control unit or the control device 26.

If for example a switching element in the freewheeling circuit is not able to block a voltage, this corresponds to a short-circuit fault. The switch voltage u_{FP} or U_{FN} now cannot be built up after the exemplary time t₄ or t₀. In some embodiments, the control unit checks the voltage state of u_{FP} and/or u_{FN} at a suitable time, for instance in the interval [t₁, t₂], for example at the time t₁ or in the time interval [t₅, t₆], for instance at the time t₅, in order to detect a short-circuit fault and to avoid a short circuit between the freewheeling circuit and the other switching elements.

With reference to FIG. 3b, a fault detection method able to be implemented by the control device 26 is illustrated in a table, wherein the open fault is described using the term “open” and the short-circuit fault is described using the term “short circuit”.

The round brackets used in the time intervals, for example (t₄, t₆], refer to the exclusion of the exact time since, at the start of the time intervals, a switching element is currently switched off and the build-up of the switch voltage (U_{FN} Or u_{FP}) begins exactly at this time. The transient switch voltage remains at the state of a low voltage at this time t₀, t₄, and so the exact time for the measurement may be less suitable. For this reason, embodiments for other operating modes, in particular in the case of CCM or DCM, make provision, after the switching elements S_{1/2} or S_{3/4} have been switched on, to carry out the measurement only after a small delay, since it may be expected that, in these cases, the switch voltage will increase only after S_{1/2} or S_{3/4} have been switched on.

The control device 26 may be configured to detect whether the respectively output logic signal “1” or ONE or “0” or zero corresponds to the expected value and, in the event of a deviation, to detect or identify a fault.

In the event that the control device 26 detects a fault, the control device 26 may abort the operation of this phase circuit and carry out one or more protective measures described herein. The switching elements 33₁, 33₂, 33₃ and 33₄ (S₁, S₂, S₃ and S₄) may for example be switched off in this case, and the control signals for the freewheeling circuit may remain switched on or be switched on.

In the event of an open fault, the freewheeling circuit is not operational, and the coil current i_{L} is commutated, immediately after switch-off of the switching elements on one side, for example S₁ and/or S₂ or S₃ and/or S₄, to the other side through the body diode or freewheeling diode of the switching elements S₃ and/or S₄ or S₁ and/or S₂ into the capacitor 36₁ or 36₂. A higher voltage now acts across a switching element of the freewheeling circuit, and in the process the erroneous voltage state is able to be detected by the monitoring device 53. As an example, FIG. 3c shows a schematic curve of the open fault in the switching element S_{FP} or 33₂. In the time interval [t₃, t₄], the voltage u_{FP} has a higher voltage. Using the monitoring device 53, the fault is detected by the control device 26 and the phase circuit is switched off. The coil current may then be dissipated until it reaches zero by the body diodes or freewheeling diodes of switching elements S₃ and S₄. FIG. 3d shows a scenario for a short-circuit fault; after the time t₄, S_{FP} should be switched off, but its voltage should not be built up due to the short-circuit fault. At the time t5, the fault is detected by the control device 26 using the monitoring device 53 and the phase circuit is switched off. In the process, the coil current in the freewheeling circuit is consumed slowly until it reaches 0.

In FIG. 3a and FIG. 4a, the switching elements S_{3/4} are actively conductive in the period between the times t₅ and t₆. The difference between the cycles of FIG. 3a and FIG. 4a is that the coil current, during the described zero voltage switching (ZVS), is automatically directed to the next step after the switching elements have been switched off; see FIG. 3a. As shown in FIG. 4a, the switching elements S_{3/4} are switched off at the time t₆. Therein, however, the coil current then still goes in the positive direction, that is to say the coil current still has a positive mathematical sign, and therefore the coil current passes further through the body diode of S_{3/4}. At the time t₇, the switching element S_{FP} is switched on in the freewheeling circuit, and now the coil current is then commutated with hard switching in the freewheeling circuit. In the unidirectional variant, which is described in connection with FIG. 6a, such operation using the diodes D_{1/2} works using the same principle in a CCM mode.

FIG. 4a shows an exemplary timing diagram of drive signals for the switches S₁-S₄ and the switches of the freewheeling path 32′ from FIG. 2a during a continuous current mode (i_{LUG}>0), CCM, and a discontinuous current mode (i_{LUG}=0), DCM. While in FIG. 3a the TraCM mode is shown with a coil current also flowing in the negative direction, FIG. 4a shows a regular CCM mode comparable to a unidirectional variant.

In the continuous mode, CCM, the upper and lower current limits have the same mathematical sign within a switching period. The criterion for zero voltage switching, ZVS, is not met for every switching operation here, and so some switching elements switch with a hard switching operation.

FIG. 4a shows the curves of the coil current it and the gate signals for a positive continuous coil current. The main difference compared to the trapezoidal current mode from FIG. 3a with zero voltage switching occurred in this case at switch-off of the switching element S_{FN} at the time t₀ and of the switching elements S_{3/4} at the time t₆. Since the transient coil current i_{L} still has a positive mathematical sign, the criterion for capacitive commutation (zero voltage switching) is not met; after it has been switched off, the coil current continues to flow through its diode. Current commutation then takes place at switch-on of the switching elements S_{1/2} at the time t₁ and of the switching element S_{FP} at the time t₇. In particular, at the time t₁, the switching elements S_{FN}, S_{1/2} switch with hard switching and, at the time t₇, the switching elements S_{FP} and S_{3/4} switch with hard switching.

In this mode, the fault detection method of the monitoring device 53 for the open fault and short-circuit fault in S_{FP} remain similar or identical to the method for trapezoidal current mode; see FIG. 3a-d in this regard. A deviation consists in that the short-circuit fault in S_{FN} is detected and checked shortly after the switch-on of switching elements S₁ S₂ or 18₁, 18₂ with a short delay of the order of approximately 20 ns to 200 ns. Other delay values are by all means possible. The table in FIG. 4b shows the correlation of the fault detection method for this operating mode, as may be implemented based on the voltage monitoring circuit 57 or the monitoring device 53 using the control device 26. In the event of a detected fault, the control device 26 may be configured to use or apply the same protective measure as for the trapezoidal current mode TraCM.

For a negative continuous coil current, FIG. 5a shows a schematic exemplary illustration of the drive signals for the switching elements S₁-S₄ and the switching elements of the freewheeling path 32′ together with an exemplary schematic curve of the coil current i_{L}. Here, the hard switching takes place at switch-on of the switching elements S_{FN}, S_{1/2} at the time t₃ and of the switching elements S_{FP} and S_{3/4} at the time t₅.

FIG. 5b shows a table-based representation of an assignment, applicable for FIG. 5a, of the faults, as may be able to be identified by the monitoring device 53. In this mode, the fault detection method for the open fault and short-circuit fault in S_{FN} remains the same as the method for the trapezoidal current mode. Only the short-circuit fault in S_{FP} or the switching element 33₂ is detected and checked shortly after switch-on of switching elements S_{3/4} or 18₃, 18₄ with a short delay of the order of for example approximately 20 ns to 200 ns. The table in FIG. 5b shows, in association, the correlation of the fault detection method for this operating mode. The same protective measure as for the trapezoidal mode may be used for the detected fault.

It is possible to leave the switching element S_{FN} permanently switched off for a continuously positive coil current; conversely, it is possible to permanently switch off the switching element S_{FP} for a continuously negative coil current. In the case of a static implementation of a DC-DC converter, in accordance with embodiments, the respective element may also be substituted, for example by a diode, which is switched in accordance with the body diode of the substituted element. One possible control strategy for the control device may be configured such that the switching element 33₁, denoted S_{FN}, is able to be switched off at the coil current denoted it as soon as this is positive (P), and the switching element 33₂, denoted S_{FP}, is able to be switched off at the coil current denoted it as soon as this is negative (P), this being shown in the indices S_{FP} and S_{FN}. This means that, if the coil current flows continuously in one direction (CCM), one of the two transistors 33₁ and 33₂ may also be excluded from an active control strategy, for instance because its freewheeling diode (in the case of a MOSFET body diode) is able to conduct the current. The control logic may thus be simplified. In FIG. 3a, in the interval 54i, the transistors 33₁ and 33₂ of the freewheeling path are switched on in an overlapping manner in order to optimize the lower conductive losses.

However, in order to reduce conductive losses in the freewheeling step or to simplify the control logic, the bidirectional switch of the freewheeling path may also be driven using the control strategy for the trapezoidal current mode.

A discontinuous current mode may be a special continuous current mode in which one of the current limits is set to zero. The control method for the continuous current mode may also be used for the discontinuous current mode.

FIG. 6a shows a schematic block diagram of a DC-DC converter 20′ according to an embodiment. It corresponds essentially, in terms of its design, to the DC-DC converter 20, wherein the switching elements 18₃ and 18₄ of the DC-DC converter 20 are replaced by the diode elements 56₁ and 56₂, respectively, which are each arranged in the blocking direction with regard to the potentials φ₂₊ and φ₂₋. This may be considered to be a unidirectional variant of the DC-DC converter 20 and may be used in special applications. In this variant, in which the switching elements S_{3/4} are replaced by the diodes D_{1/2}, although provision is not made for bidirectional energy transmission, this makes it possible to save on material costs with regard to the switching elements S_{3/4}.

The operating principle for the unidirectional variant of the DC-DC converter 20′ is in this case the same as a continuous current mode or a discontinuous current mode in the bidirectional topology, the control method of which may therefore be applied directly. Since the switching elements S_{3/4} are replaced by diodes D_{1/2}, the corresponding gate signals of FIG. 4a and FIG. 5a are not used further.

With reference to FIG. 3a, FIG. 4 and FIG. 5a, the control device may be configured to switch the freewheeling interval 54 at times at which the control device switches the circuit path 14 into a blocking state and the circuit path 16 is in a blocking state. The blocking state of the circuit path 16 may in this case be maintained actively through appropriate driving by way of the control device, as is implemented for example in the DC-DC converter 20. However, diodes are installed in the DC-DC converter 20′. These cannot usually be actively switched to the blocking state. However, since the freewheeling circuit or the freewheeling path 32′ actively commutates the coil current, the diodes 56₁ and 56₂ have a blocking effect, and so the circuit path 16 is in a blocking state.

In other words, the topology according to FIG. 6a, in a unidirectional design, forms a sub-form of the variant according to FIG. 2a. As in the bidirectional topology of the DC-DC converter 20 as well, the switching elements S_{3/4} are not activated, but rather their body diode conducts the current. In terms of cost, S_{3/4} may be replaced by being replaced with diodes D_{1/2} for a unidirectional application, and the converter may for example only still be operated in CCM mode and/or DCM mode, where the coil current is dissipated until it reaches zero. Otherwise, the topologies may be identical to one another. The control method may likewise be the same as in normal CCM mode (or DCM mode). Proceeding from FIG. 4a, in a topology according to FIG. 6a, only the control signals for the switches S_{3/4} may be ignored, wherein it should be noted, particularly at the time t₇, that the coil current commutates in the freewheeling path only after S_{FP} has been switched on.

FIG. 6b shows the curves for the coil current and the gate signals for the unidirectional variant of FIG. 6a based on the illustration of FIG. 4a.

One advantageous refinement of embodiments described herein lies in the possibility of limiting the switching frequency of the DC-DC converter. According to an embodiment, the control device of a DC-DC converter according to the invention is configured to extend a duration of the freewheeling interval compared to a preceding freewheeling interval in order to reduce a switching frequency of the DC-DC converter over several switching cycles. The switching frequencies may be coupled here in the circuit, which may lead for example to the diodes being switched passively at the same frequency as the transistors, as illustrated in FIG. 6c.

FIG. 6c shows one possible effect of an embodiment in which the control device is configured to extend a duration of the freewheeling interval compared to a preceding freewheeling interval in order to reduce a switching frequency of the first and second circuit paths over several switching cycles and/or in order to shorten the duration of the freewheeling interval compared to the preceding freewheeling interval, in order to increase the switching frequency of the first and second circuit paths.

This makes it possible to set a switching frequency independent of the operating point and thus to enable different operating states. This procedure is possible both for actively controllable elements in the second circuit path, for instance of the DC-DC converter 20, and for passively switching elements, diodes, in the second circuit path, for instance of the DC-DC converter 20′. Thus, in each variant, the two circuit paths are able to be switched at the same, matching frequency. If the switching elements of the second circuit path are transistors, for example, they may be driven using appropriate control signals at the same switching frequency as the elements of the first circuit path. If on the other hand at least one of the elements is implemented as a diode, this is switched passively between the conductive and blocking states automatically at the same frequency.

The switching period T_{S} may thus be shortened to a switching period T_{S}*, and the frequency may be increased analogously. The freewheeling intervals 54₀, 54₁ and 54₂ illustrated in FIG. 3a and/or FIG. 6b may likewise be shortened in order to obtain shortened freewheeling intervals 54₀*, 54₁* and 54₂*, which also directly influences the current curve in terms of its frequency. Similar results are obtained when the freewheeling intervals and/or the switching period T_{S} are extended.

As an alternative, the control device may shorten the duration of the freewheeling interval compared to the preceding freewheeling interval in order to increase the switching frequency of the DC-DC converter. The control device may in this respect be configured to leave the duration of the freewheeling interval unchanged or to shorten or increase it and adjust it over time, depending on the requirements of the switching frequency.

Due to the build-up time and the dissipation time of the coil current in the inductive element 22, the switching frequency implemented in the DC-DC converter topology may be strongly dependent on the operating state. For a lower output power, the switching frequency required according to the operating state may go beyond the manageable frequency responses of the control system, that is to say exceed them. This may cause problems or confusion in the control logic and increase EMC (electromagnetic compatibility) problems. Furthermore, it is possible that the losses in the inductive element and/or in other switching elements increase, which is disadvantageous. In order to limit the switching frequency during operation, the duration of the freewheeling interval or of the freewheeling step may be actively adjusted, for example extended, in the control system. This includes shortening it should the extension no longer be necessary or no longer be advantageous due to a changed operating state. Extending the duration of the freewheeling interval makes it possible to keep the complete switching duration that is implemented sufficiently long. In one specific embodiment, the extended duration of the freewheeling interval may be flexibly distributed, adjusted and/or added in each originally provided freewheeling step.

Reference is made below to the possibilities for fault detection and possible protection methods that are obtained using the switchable freewheeling path described herein and, where applicable, in cooperation with the detection device. For this purpose, reference is made to the circuit topologies of FIG. 2a and FIG. 6a, in particular to the voltage drop u_{R1} across the resistive element 44 and the potentials φ₁₋ and φ₂₋ on the circuit paths and the potentials φ₁₋ and φ₁₊ and φ₂₋ and φ₂₊.

The possibilities for fault detection discussed herein are based in part on the findings outlined below. The occurrence of a voltage peak as potential u_{R1} may be used by the control device as an indication or signal that a fault is present in the circuit. The potential change thus detected may be cause for the control device to switch the circuit path 14 and/or the circuit path 16 to a blocking state.

In other words, since a built-up coil current is intended to flow further into a path when a switching element happens to alloy due to excess temperature, this switching element immediately loses its blocking capability and remains in the conductive state. If the converter now continues to operate, the two DC networks are connected by the faulty switching element and the other diagonally positioned switching element. The converter then loses its isolation. This fault may be called a diagonal connection in the topology.

In order to detect this fault and protect the isolation of the converter, the detection device 42 monitors the potential change between the two DC networks. When a diagonal connection occurs, the potential difference between the two circuit paths changes abruptly. Since the voltage across a capacitor C₁ cannot be changed abruptly, the diagonal connection then causes an abrupt voltage as the fault detection signal across the resistor R₁.

If for example the switching elements S₁ and S₄ are connected erroneously, then the potentials φ₁₊ and φ₂₋ are short-circuited. The potentials φ₁₊ and φ₁₋ are abruptly shifted transiently in the negative direction and the potentials φ₂₊ and φ₂₋ are shifted in the positive direction. At this time, a negative possibly transient voltage u_{R1}(0) is present across the R₁:

$${u}_{R 1} ( 0 ) = - {φ}_{1 +} + {φ}_{2 -} < 0$$

the following may apply for a voltage curve:

$${u}_{R 1} ( t ) = ( - {φ}_{1 +} + {φ}_{2 -} ) \cdot {e}^{- \frac{t}{τ}} , τ = {R}_{1} \cdot {C}_{1}$$

In another case, if the switching elements S₂ and S₃ are connected erroneously, then the potentials φ₁₋ and φ₂₊ are short-circuited. The potentials φ₁₊ and φ₁₋ are abruptly shifted transiently in the positive direction and the potentials φ₂₊ and φ₂₋ are shifted in the negative direction. At the same time, a positive possibly transient voltage is present across the R₁:

$${u}_{R 1} ( 0 ) = - {φ}_{1 -} + {φ}_{2 +} > 0$$

the following may apply for a voltage curve:

$${u}_{R 1} ( t ) = ( - {φ}_{1 -} + {φ}_{2 +} ) \cdot {e}^{- \frac{t}{τ}} , τ = {R}_{1} \cdot {C}_{1}$$

Since, during normal operation during switching, the junction capacitance of the switching elements is recharged, a weak interfering signal in the detection device 42 may also drop across the resistive element 44 or may be identifiable. In order to detect a fault case accurately and reliably, according to an embodiment, the voltage pulse across the resistive element 44 is confirmed after a time delay t_{V} related to the switching operation. If the transient voltage u_{R1}(t_{V}) has an absolute value even greater than a threshold value, then this may be detected as a fault. By way of example, the threshold value may be defined with a value of at least 50%, at least 30% or up to 20%, and lower values or larger values relative to a theoretical maximum

$${u}_{R 1} ( 0 ) \cdot {e}^{- \frac{{t}_{V}}{τ}} .$$

The threshold value makes it possible to detect interfering signals that occur during normal operation not as faults, but to be able to use an actual fault case reliably as a trigger for the countermeasures described herein.

The time delay t_{V} is advantageously longer than the commutation period when switching the switching elements during normal operation. The commutation period during normal operation is typically in the range between 100 ns and 1,000 ns and may be understood as a kind of upper time limit or worst-case limit. Since, in a fault-free case, any voltage pulse is dissipated during the commutation period, it is possible to achieve a situation, with a greater duration tᵥ, whereby a voltage level or potential that is still present following expected decaying of the voltage during the commutation period is able to be interpreted as a fault. This also shows that the detection at the beginning of the commutation period with confirmation after the time tᵥ enables reliable two-stage detection, but detection only after the time tᵥ alone may already be sufficient, since the commutation period has elapsed.

The time constant τ of the RC member of the detection device 42 is configured, according to an embodiment of the present invention, such that the dropped voltage u_{R1}(t_{V}) across the resistive element 44 after the delay time tᵥ is still able to be detected properly and distinguished from noise; for example, the time constant may be configured so as to be three times the time delay, that is to say τ=3·t_{V}.

In particular, an erroneous potential shift may take place advantageously or only at the end of a freewheeling step or switch-on of a switching element after a freewheeling step. Therefore, an inoperative switching element, which, according to the switching sequence, should be switched off at the start of the last freewheeling step, is able to be diagnosed based on the activated gate signals.

FIG. 6d shows an exemplary table-based representation of fault detection, as may be carried out for example using the optional monitoring device 53 with the control device 56. For the variant of FIGS. 6a and 6b, it is possible to use the above-explained fault detection method for CCM or DCM mode with a positive coil current. A deviation may consist in that the short-circuit fault in S_{FP} is detected and checked shortly after the switch-off of the switching elements S_{FP} or 33₂ with a short delay. The short delay may in this case for example have a value of 50 ns to 200 ns, wherein in particular larger values are also possible, in particular with regard to higher time delays, just as in other embodiments, it then being accepted here however that correspondingly interfering or damaging currents will flow. For this purpose, it is stated that this delay for detection, therefore detection delay, does not necessarily have a specific value or range, rather the time delay may be oriented to the short-circuit capability of the switching element or be designed or set depending thereon. Some switching elements or MOSFETS may allow up to 1 us for a short circuit, but others may allow shorter. The table in FIG. 6d shows the correlation of the fault detection method. In the event of a detected fault, the control device 26 may switch off the switching elements S₁, S₂ or 18₁, 18₂ and leave the control signals for the freewheeling circuit switched on.

The embodiments described herein in connection with fault detection are understood to mean that a target value for the voltage drop across the monitored element has a first value in a conductive state of the freewheeling path, and has a second value different from the first value in a non-conductive state. The control device may be configured to detect the fault state based on a deviation of an actual voltage drop from the first value in the conductive state and/or from the second value in the non-conductive state, this being able to be carried out for example based on the binary value output by the comparator of the voltage monitoring circuit.

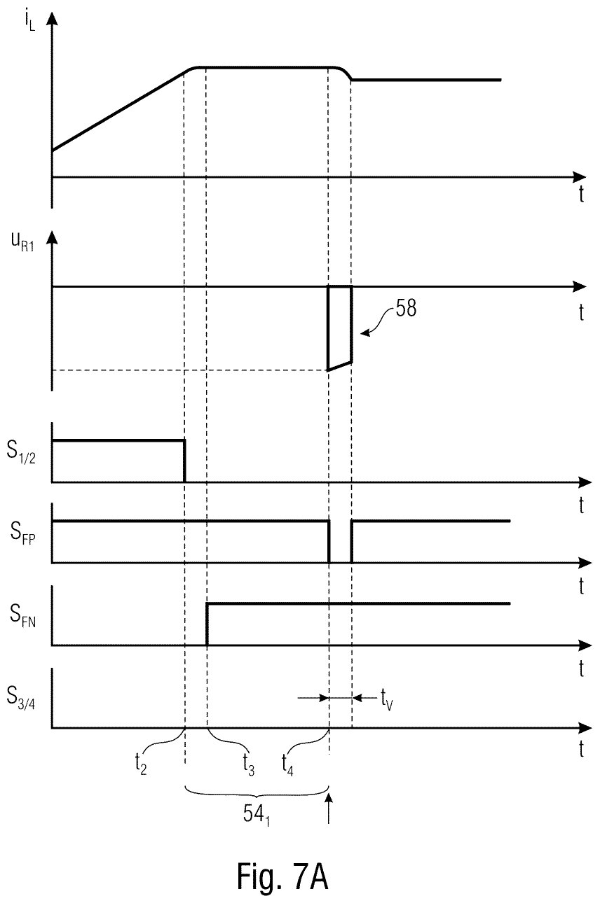

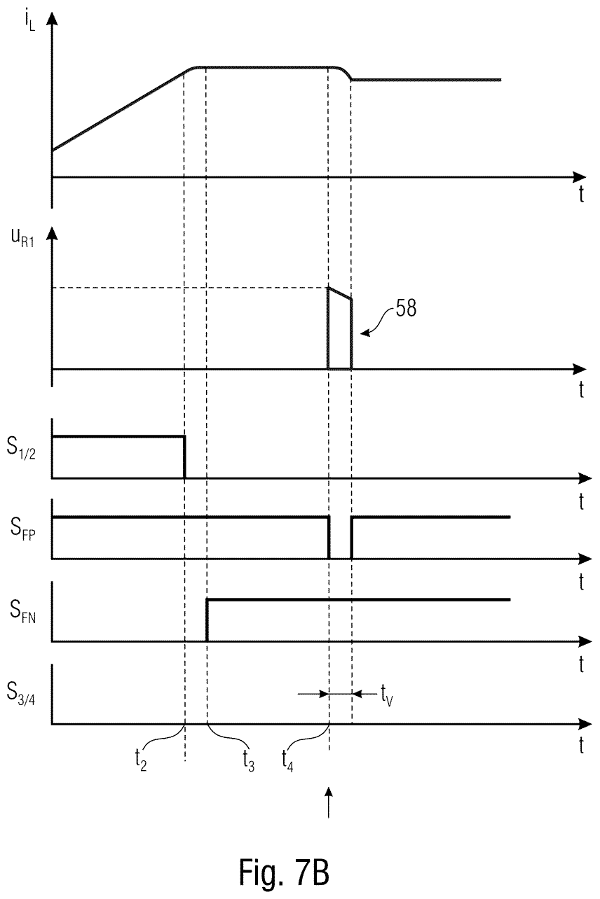

FIG. 7a and FIG. 7b show the fault detection at switch-off the switching element S_{FP}. The fault detection is triggered here on the switching-off gate signal edge of the switching element S_{FP}. If the switching element S₁ (FIG. 7a) is defective, the diagonal connection causes a negative voltage signal in the detection device 42. If the switching element S₂ (FIG. 7a) is defective, the diagonal connection causes a positive voltage signal in the detection device 42.

In order to filter out the interference from the recharged junction capacitance, the fault detection signal should be confirmed in a set delay time t_{V}, which normally lasts from a few hundred ns to thousand ns. This means that the control device may be configured to detect the potential change again with a delay time of at most 800 ns, at most 500 ns or at most 200 ns, and to use it for checking purposes. If the fault detection signal is still active after the delay, the fault is confirmed and the fault protection is activated at the same time or in response thereto. As a result, the switching elements S₁, S₂, S₃, S₄ are switched off and the switching elements in the bidirectional switch or freewheeling path are switched on permanently. The diagonal connection is thereby broken. The other three switching elements make it possible to continue to maintain the isolation, and the energy stored in the coil 22 is released into the bidirectional switch. This phase circuit 34 of the DC/DC converter has to be deactivated. The fault detection signal may be used to detect the fault in the switching element S₁ or S₂.

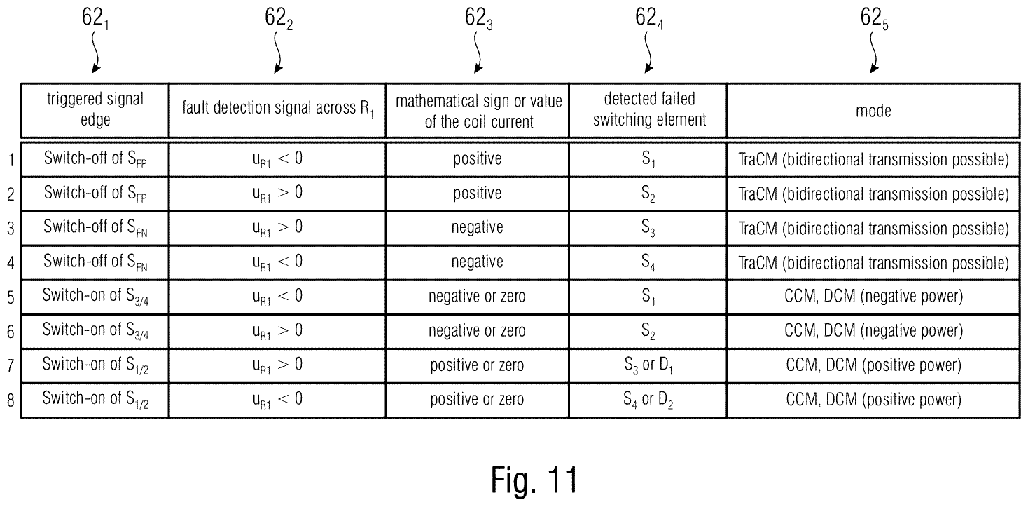

The voltage signal 58 that still occurs after the delay time t_{V} thus in itself already enables detection of the presence of a fault state. The fault detection may be configured differently. During regular operation of the DC-DC converter, a voltage drop may thus occur in the detection device 42 within the duration t₂ and t₅, see for example FIG. 3a and FIG. 4a. However, these are then dependent on a short time period and on the commutation period of the switched elements, such that they have decayed after the appropriately set duration tᵥ. A check as to whether a corresponding potential or the voltage signal 58 is still present, or alternatively even present at all, at a time t₄+tᵥ may therefore provide information that the voltage signal was not triggered due to regular operation, but rather by a fault in the DC-DC converter. This may, on the one hand, trigger countermeasures to the effect that the freewheeling path is switched to a conductive state and/or the switches S₁ and S₂ or S₁ to S₄, if they are still operational, are switched to an open state, and, on the other hand, may also be used for fault analysis, which is described in connection with FIG. 11. However, it may likewise be the case, in a DC-DC converter, that the amplitude of the voltage signal 58, due to regular operation, is far below the theoretically possible level, meaning that, as an alternative or in addition to considering the time tᵥ, it is also possible to implement a threshold value decision regarding the voltage signal 58 by way of the detection device 42 and/or the control device 26 as to whether or not a detected pulse or voltage curve should be regarded as a fault, this being able to be applied for the rising and/or falling edge and as an alternative or in addition to evaluating only one of the two edges or both edges.

As will be explained below, considering the time of occurrence and considering a mathematical sign of the voltage signal 58 also makes it possible to localize the faulty element. According to an embodiment, provision is made for a DC-DC converter in which the occurrence of the potential change in response to driving of a driven switchable element, for example one of the switches 18₁-18₄ and/or the switches 33₁ or 33₂ or a driven switchable element in the circuit path 14, the circuit path 16 and/or the freewheeling path is indicated unambiguously as a defect of another element of the converter circuit.

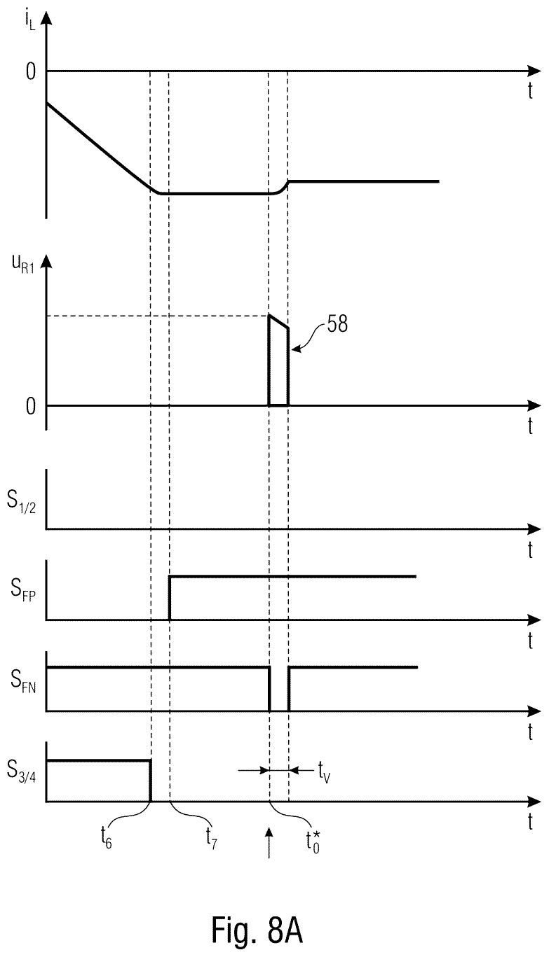

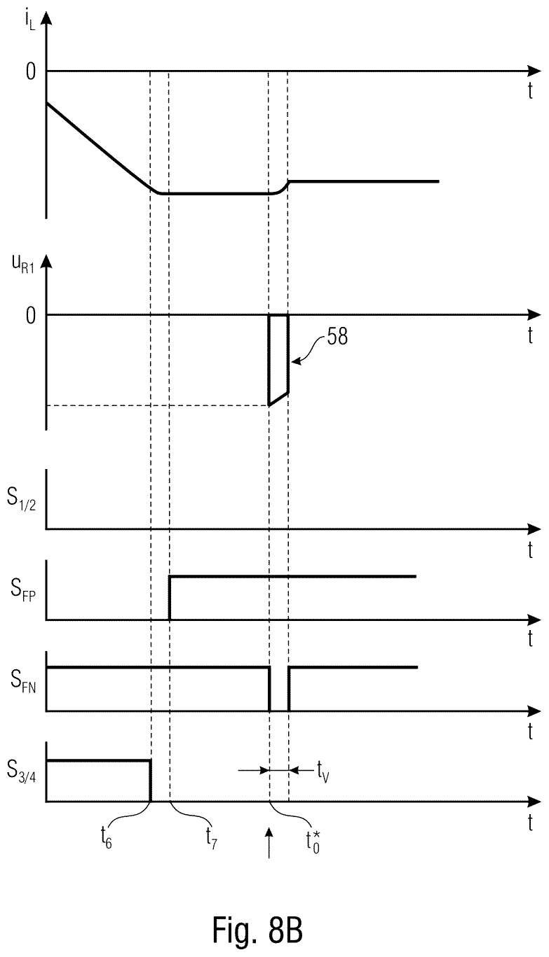

In FIG. 8a and FIG. 8b, the fault detection at switch-off of the switching element SEN is illustrated by way of example. The fault detection is triggered here on the switching-off gate signal edge of the switching element S_{FN}. If the switching element S₃ (FIG. 8a) is defective, the diagonal connection causes a positive voltage signal in the detection device 42. If the switching element S₄ (FIG. 8b) is defective, the diagonal connection causes a negative voltage signal in the detection device 42. If the fault detection signal is still active after a delay t_{V} in accordance with FIG. 7a-b for confirmation, the fault is confirmed. Fault protection is activated immediately so that the switching elements S₁, S₂, S₃, S₄ are switched off and the switching elements in the bidirectional switch are switched on permanently. The fault detection signal may be used to detect the fault in the switching element S₃ or S₄.

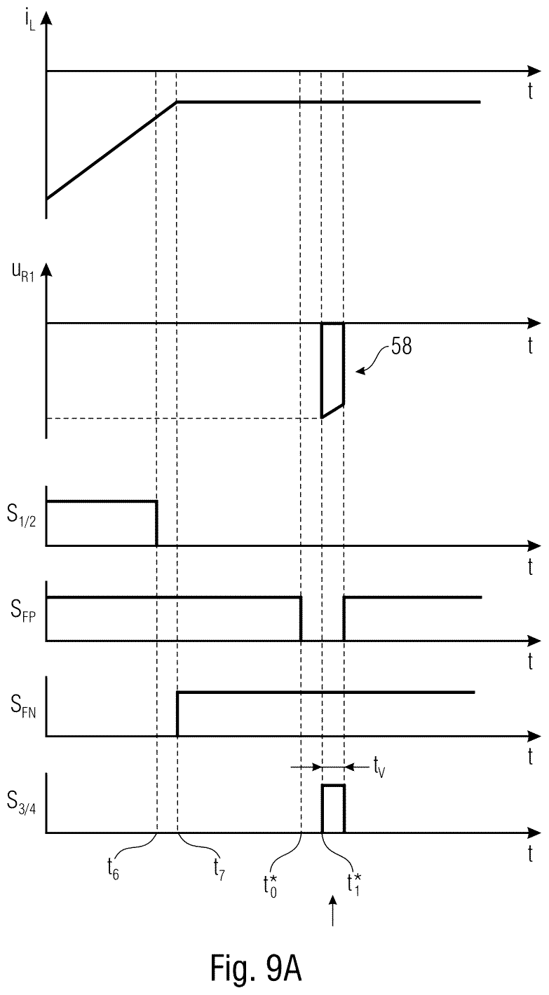

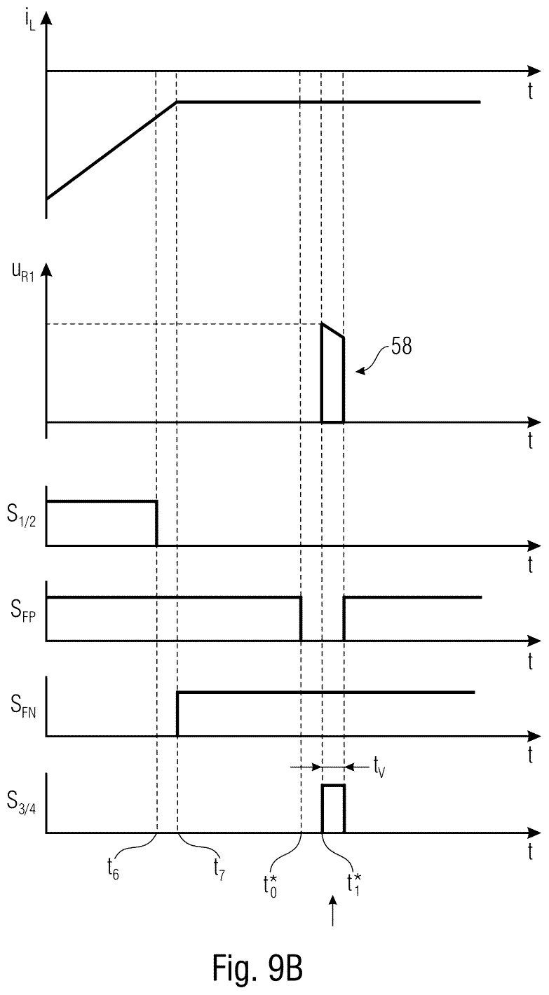

FIG. 9a and FIG. 9b illustrate, by way of example, fault detection at switch-on of the switching element S_{3/4}. The fault detection is triggered here on the switching-on gate signal edge of the switching element S_{3/4}. If the switching element S₁ (FIG. 9a) is defective, the diagonal connection causes a negative voltage signal in the detection device 42. If the switching element S₂ (FIG. 9b) is defective, the diagonal connection causes a positive voltage signal in the detection device 42. If the fault detection signal is still active after a delay t_{V} in accordance with FIG. 7a-b and FIG. 8a-b for confirmation, the fault is confirmed. Fault protection is activated immediately so that the switching elements S₁, S₂, S₃, S₄ are switched off and the switching elements in the bidirectional switch are switched on permanently. The fault detection signal may be used to detect the fault in the switching element S₁ or S₂.

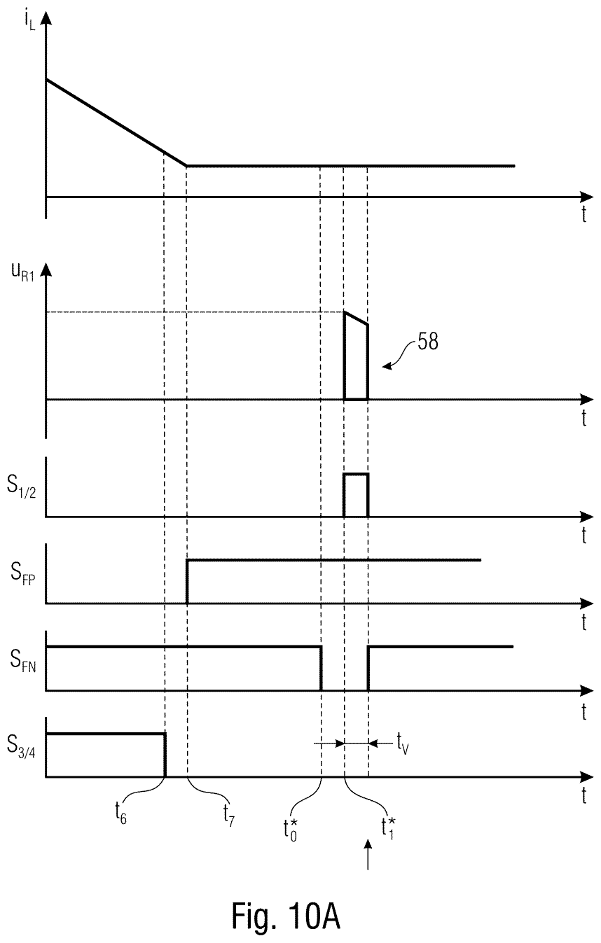

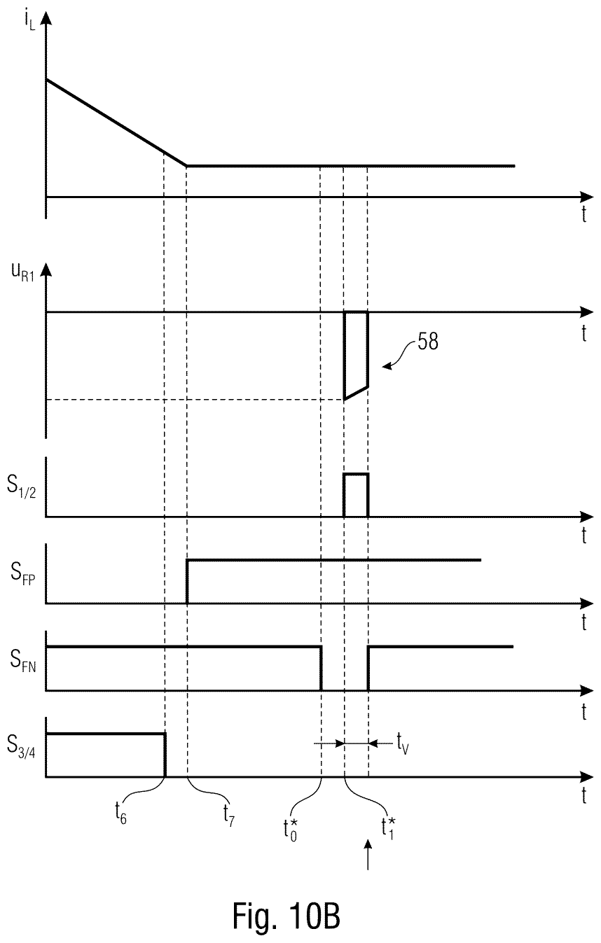

FIG. 10a and FIG. 10b illustrate, by way of example, fault detection at switch-on of the switching element S_{1/2}. The fault detection is triggered here on the switching-on gate signal edge of the switching element S_{1/2}. If the switching element S₃ (FIG. 10a) is defective, the diagonal connection causes a positive voltage signal in the detection device 42. If the switching element S₄ (FIG. 10b) is defective, the diagonal connection causes a negative voltage signal in the detection device 42. If the fault detection signal—as described in connection with FIG. 7a-b, FIG. 8a-b and FIG. 9a-b—is still active after a delay t_{V} for confirmation, the fault is confirmed in one possible embodiment. Fault protection is activated immediately so that the switching elements S₁, S₂, S₃, S₄ are switched off and the switching elements in the bidirectional switch are switched on permanently. The fault detection signal may be used to detect the fault in the switching element S₃ or S₄.

For the unidirectional variant of a DC-DC converter described herein, the diodes D1 and D2 or 56₁ and 56₂ in the fault detection may correspond to the switching elements S₃ and S₄ or 18₃ and 18₄. One difference may be that the coil current does not have a negative mathematical sign here, and is therefore positive or has a value of zero.

FIG. 11 shows one example of a table for the breakdown of decision conditions for fault detection or fault localization based on the voltage signal 58 together with the operating mode of the DC-DC converter and the time within a circuit cycle. A column 621 indicates, for rows 1-8 of the table, which event triggers the voltage signal 58. In rows 1 and 2, this is the switch-off of the switch S_{FP} or 33₂, and in rows 3 and 4, this is the switch-off of the switch S_{FN} or 33₁. In rows 5 and 6, this is the switch-on of the switching elements S_{3/4}, that is to say the switches 18₃ and 18₄. Rows 7 and 8 indicate the switch-on of the switching elements S_{1/2} or 18₁ and 18₂. With reference to the timing diagram of FIG. 3a, rows 1 and 2 relate to the time t₄, rows 3 and 4 relate to the time t₀ or t₀*, rows 5 and 6 relate to the time t₅ and rows 7 and 8 relate to the time t₁.

With reference to column 62₂, each of these pairwise assignments of rows 1/2, 3/4, 5/6 and 7/8 is distinguished in terms of whether the voltage signal 58 has a negative or positive mathematical sign, that is to say u_{R1}<0 or u_{R1}>0 is present.

A column 62₃ combines this with detection of a mathematical sign of the coil current and a column 62₅ indicates the operating state TraCM, CCM or DCM in which the DC-DC converter is operated.

Column 62₄ indicates which of the switching elements should be considered defective or to have failed.

Since the diagonal connection only occurs in the event of failure of a switching element, the voltage signal 58 is not activated or identified during normal operation. Therefore, the eight fault detection cases illustrated in the table of FIG. 11 may be simultaneously monitored in parallel in the control system.

It is likewise clear from the table of FIG. 11 in conjunction with FIG. 3a that converter circuits that are driven with a phase offset in relation to one another are able to deliver a correspondingly unambiguous signal or correspondingly unambiguous information at different times, as long as it is ensured that the indicated times in FIG. 3a do not overlap.

For a multi-phase application, the phase circuits 34 may preferably be clocked in interleaved fashion. In this case, the switching operations in the phase circuits 34 are distributed sequentially over time, for which reason a common detection device 42 for a plurality of phase circuits for fault detection is possible. In particular, the freewheeling step or freewheeling interval obtained using the bidirectional switch of the freewheeling path 32 or 32′ offers a possibility of adjusting the phase offset and the switching frequency between the plurality of phases. According to an embodiment, provision is therefore made for the control device to switch different phase circuits 34 of the DC-DC converter 20 or 20′ individually and to adjust them with regard to the switching frequency, for instance by adjusting the duration of the freewheeling interval as described herein, for example in order to keep the times relevant for the fault detection according to FIG. 11 temporally disjunct from one another.

As an alternative or in addition, it is possible to carry out combinatorial monitoring of several phase circuits only in groups or to couple each phase circuit 34 with its own detection device 42, meaning that interleaved clocking between the phase circuits 34 is no longer necessary. The detection device 42 is preferably connected on both sides to respective and mutually different circuit paths 14 and 16. If a different coupling point is used instead of the illustration shown, then the mathematical sign of U_{R1} may change, this easily being able to be taken into account in the fault detection.

Embodiments provide DC-DC converters having a fault protection measure against the failure of one or more transistors. These DC-DC converters connect two different DC networks and implement a unidirectional or bidirectional energy transmission between them. Due to the potential isolation (pseudo-isolation) based on the semiconductors, this converter enables transformerless isolation. It may in particular be ensured that this converter is able to maintain or survive its isolation capability between two DC networks in the event of a simple fault. A fault detection method according to the embodiments described herein is advantageous here, and the protective measure may be used with the corresponding protective circuit.

Although some aspects have been described in connection with a device, it goes without saying that these aspects also constitute a description of the corresponding method, meaning that a block or a component of a device should also be understood as a corresponding method step or as a feature of a method step. Similarly, aspects that have been described in connection with or as a method step also represent a description of a corresponding block or detail or feature of a corresponding device.

Depending on specific implementation requirements, embodiments of the invention may be implemented in hardware or software. The implementation may be carried out using a digital storage medium, for example a floppy disk, a DVD, a Blu-Ray disc, a CD, a ROM, a PROM, an EPROM, an EEPROM or a FLASH memory, a hard drive or another magnetic or optical memory storing electronically readable control signals that interact with or are able to interact with a programmable computer system such that the respective method is carried out. The digital storage medium may therefore be computer-readable. Some embodiments according to the invention thus include a data carrier containing electronically readable control signals that are able to interact with a programmable computer system such that one of the methods described herein is carried out.

In general, embodiments of the present invention may be implemented as a computer program product including a program code, wherein the program code has the effect of carrying out one of the methods when the computer program product runs on a computer. By way of example, the program code may also be stored on a machine-readable carrier.

Other embodiments include the computer program for carrying out one of the methods described herein, wherein the computer program is stored on a machine-readable carrier.

In other words, one embodiment of the method according to the invention is thus a computer program including a program code for carrying out one of the methods described herein when the computer program runs on a computer. A further embodiment of the methods according to the invention is thus a data carrier (or a digital storage medium or a computer-readable medium) on which the computer program for carrying out one of the methods described herein is recorded.

A further embodiment of the method according to the invention is thus a data stream or a sequence of signals that represents the computer program for carrying out one of the methods described herein. The data stream or the sequence of signals may for example be configured to be transferred via a data communication connection, for example over the Internet.

A further embodiment includes a processing device, for example a computer or a programmable logic component, which is configured or adapted to carry out one of the methods described herein.

A further embodiment includes a computer on which the computer program for carrying out one of the methods described herein is installed.

In some embodiments, a programmable logic component (for example a field-programmable gate array, an FPGA) may be used to carry out some or all of the functionalities of the methods described herein. In some embodiments, a field-programmable gate array may interact with a microprocessor in order to carry out one of the methods described herein. In general, the methods are carried out, in some embodiments, by any hardware device. This may be general-purpose hardware such as a computer processor (CPU) or hardware specific to the method, such as an ASIC for example.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A DC-DC converter comprising:
a converter circuit comprising a switchable first circuit path that is in a conductive state in a first time interval and that comprises at least a first and a second switchable element interconnected in series, and comprising a second circuit path that is coupled to the first circuit path by way of an inductive element and that is in a conductive state in second time interval disjunct from the first time interval, wherein there is a time lag between the first time interval and the second time interval;
a control device configured to switch the first circuit path; and
a switchable freewheeling path coupled in parallel with the inductive element, wherein the control device is configured to switch the switchable freewheeling path temporarily to a conductive state in a freewheeling interval during the time lag.

2. The DC-DC converter according to claim 1, wherein the second circuit path comprises a third switchable element and a fourth switchable element; wherein the control device is configured to switch the third switchable element and the fourth switchable element.

3. The DC-DC converter according to claim 1, wherein the freewheeling path, in a conductive state, is in a bidirectionally conductive state and/or, in a non-conductive state, is in a bidirectionally blocking state.

4. The DC-DC converter according to claim 3, wherein the freewheeling path comprises at least one switching element that, in the conductive state, is in a bidirectionally conductive state and, in the non-conductive state, is in a bidirectionally non-conductive state; or
wherein the freewheeling path comprises a first switching element that, in the non-conductive state, is in a unidirectionally blocking state along a first direction of the freewheeling path; and a second switching element that, in the non-conductive state, is in a unidirectionally blocking state along an opposite second direction of the freewheeling path; wherein the first switching element and the second switching element are interconnected such that, in the non-conductive state, the freewheeling path is in a blocking state in the first direction and/or the second direction.

5. The DC-DC converter according to claim 1, wherein the freewheeling path comprises a first semiconductor switch and a second semiconductor switch coupled in antiseries with the first semiconductor switch, for instance mutually adjacent drain terminals or collector terminals.

6. The DC-DC converter according to claim 1, wherein the control device is configured to extend a duration of the freewheeling interval compared to a preceding freewheeling interval, in order to reduce a switching frequency of the first circuit path and of an optional second circuit path over several switching cycles; and/or to shorten the duration of the freewheeling interval compared to the preceding freewheeling interval, in order to increase the switching frequency of the first circuit path and of the second circuit path.

7. The DC-DC converter according to claim 1, wherein the first switchable element and/or the second switchable element comprises a semiconductor switch.

8. The DC-DC converter according to claim 1, comprising a detection device that is coupled to the first circuit path and the second circuit path and is configured to detect a potential change between the first circuit path and the second circuit path;
wherein the control device is configured, based on the potential change, to likewise at least partially terminate the switching of the first circuit path.

9. The DC-DC converter according to claim 8, wherein the detection device comprises an RC member comprising a resistive element, R, and a capacitive element, C, and is configured to detect a voltage drop across the resistive element and/or the capacitive element in order to detect the potential change.

10. The DC-DC converter according to claim 9, wherein the control device is configured to switch the switchable freewheeling path to a conductive state in the event of a detected potential change.

11. The DC-DC converter according to claim 8, wherein the control device is configured to switch the first circuit path and/or the second circuit path to a blocking state in the event of a detected potential change.

12. The DC-DC converter according to claim 1, comprising a monitoring device configured to monitor a voltage drop across at least part of the freewheeling path, wherein the control device is configured to detect a fault state of the freewheeling path based on the voltage drop; to at least partially terminate the switching of the first circuit path based on the fault state.

13. The DC-DC converter according to claim 12, wherein the monitoring device is configured to compare a voltage drop across a switchable element of the freewheeling path with a constant or configurable reference value, to provide a comparison result and to provide same to the control device in order to detect the fault state.

14. The DC-DC converter according to claim 12, wherein a target value for the voltage drop comprises a first value in a conductive state of the freewheeling path; and
comprises a second value different from the first value in a non-conductive state, wherein the control device is configured to detect the fault state based on a deviation of an actual voltage drop from the first value in the conductive state and/or from the second value in the non-conductive state.

15. The DC-DC converter according to claim 1, comprising a plurality of converter circuits connected in parallel;
wherein the control device is configured to drive the plurality of converter circuits with a time offset in relation to one another such that, at any time, a path of at most one converter circuit is switched; and
wherein the detection device is coupled to the plurality of converter circuits in order to unambiguously identify a potential change in each of the converter circuits.

16. The DC-DC converter according to claim 1, wherein the control device is configured to control the DC-DC converter in at least one of a continuous mode, CCM; a discontinuous mode, DCM, a trapezoidal mode with an alternating mathematical sign of the current, TraCM, and a limit mode, BCM.

17. The DC-DC converter according to claim 1, comprising a plurality of converter circuits; and
a corresponding plurality of detection devices that are each coupled to one of the plurality of converter circuits in order to monitor same.

18. The DC-DC converter according to claim 1, wherein the occurrence of the potential change in response to driving of a driven switchable element in the first circuit path, of a switchable element of a second circuit path in the second circuit path or of the switchable freewheeling path unambiguously indicates another element of the converter circuit as a defective element.
